(19) United States
(12) Patent Application Publication
(10) Pub. No.: US 2019/0114477 A1
(43) Pub. Date: Apr. 18, 2019

(54) TERMINAL APPARATUS, INFORMATION PROCESSING SYSTEM, AND METHOD OF PROCESSING INFORMATION

(71) Applicant: Takuro MANO, Kanagawa (JP)

(72) Inventor: Takuro MANO, Kanagawa (JP)

(21) Appl. No.: 16/137,687

(22) Filed: Sep. 21, 2018

(30) Foreign Application Priority Data
Oct. 17, 2017 (JP) 2017-200792

(51) Int. Cl. G06K 9/00; G06T 11/60; G06F 17/24

(52) U.S. Cl. CPC G06K 9/00416; G06F 17/241; G06K 9/00442; G06T 11/60

(57) ABSTRACT

A terminal apparatus includes circuitry to generate a plurality of content data items based on display image data displayed on a display. The circuitry further selects, from among the plurality of content data items, at least one content data item that includes stroke information indicating a stroke image, as target data subjected to detection of stroke image data to which specific attribute information is set. The stroke image is an image of a trajectory of a stroke that is a handwriting input on the display.

### CROSS-REFERENCE TO RELATED APPLICATION

This patent application is based on and claims priority pursuant to 35 U.S.C. §119(a) to Japanese Patent Application No. 2017-200792, filed on Oct. 17, 2017, in the Japan Patent Office, the entire disclosure of which is hereby incorporated by reference herein.

### BACKGROUND

### Technical Field

Embodiments of the present disclosure relate to a terminal apparatus, an information processing system, and a method of processing information.

### Related Art

A system is known, which captures an image projected by a projector, page by page, using a camera. In such a system, first image data, which is obtained by capturing a first page during being projected, is compared with second image data, which is obtained by capturing a second page that is a page transitioned from the first page, to extract information input and added to a projected image of the first page during being projected before the transition.

### SUMMARY

An exemplary embodiment of the present disclosure includes a terminal apparatus including circuitry to generate a plurality of content data items based on display image data displayed on a display. The circuitry further selects, from among the plurality of content data items, at least one content data item that includes stroke information indicating a stroke image, as target data subjected to detection of stroke image data to which specific attribute information is set. The stroke image is an image of a trajectory of a stroke that is a handwriting input on the display.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic view illustrating an example of a configuration of an information processing system, according to a first embodiment of the present disclosure;

FIG. 2 is a block diagram illustrating an example of a hardware configuration of an electronic whiteboard, according to the first embodiment;

FIG. 3 is a block diagram illustrating an example of a hardware configuration of a server apparatus, according to the first embodiment;

FIG. 4 is an illustration for explaining a use scenario of the electronic whiteboard, according to the first embodiment;

FIG. 5 is a schematic diagram illustrating functions of each apparatus included in the information processing system, according to the first embodiment;

FIG. 6 is a conceptual diagram illustrating an example of a content database, according to the first embodiment;

FIG. 7 is a conceptual diagram illustrating an example of an attribute database, according to the first embodiment;

FIG. 8 is a conceptual diagram illustrating an example of an important matter database, according to the first embodiment;

FIG. 9 is a conceptual diagram illustrating a data structure of portable document format (PDF) data, according to one of the embodiments;

FIG. 10A and FIG. 10B are illustrations of an image displayed on a display of an electronic whiteboard, according to one of the embodiments;

FIG. 11 is a conceptual diagram illustrating paged data, according to the first embodiment;

FIG. 12 is a conceptual diagram illustrating stroke arrangement data, according to one of the embodiments;

FIG. 13 is a conceptual diagram illustrating coordinate array data, according to one of the embodiments;

FIG. 14 is a diagram illustrating media data, according to one of the embodiments;

FIG. 15 is a sequence diagram illustrating an operation performed by the information processing system, according to the first embodiment;

FIG. 16 is a flowchart illustrating an example of a process of recording page data, according to the first embodiment;

FIG. 17A and FIG. 17B are illustrations for explaining an operation of the information processing system, according to the first embodiment;

FIG. 18 is an illustration for explaining a process of extracting important matter information, according to one of the embodiments;

FIG. 19 is an illustration of an example of a display displaying an important matter information list, according to the first embodiment;

FIG. 20 is a sequence diagram illustrating an operation performed by an information processing system, according to a second embodiment;

FIG. 21 is schematic diagram illustrating functions of each apparatus included in an information processing system, according to a third embodiment;

FIG. 22 is an illustration of an overview of an information processing system, according to a fourth embodiment;

FIG. 23 is a diagram illustrating a modification of the information processing system according to one of the embodiments;

FIG. 24 is a diagram illustrating another modification of the information processing system according to one of the embodiments; and

FIG. 25 is a diagram illustrating still another modification of the information processing system according to one of the embodiments.

The accompanying drawings are intended to depict example embodiments of the present disclosure and should not be interpreted to limit the scope thereof. The accompanying drawings are not to be considered as drawn to scale unless explicitly noted.

### DETAILED DESCRIPTION

The terminology used herein is for describing particular embodiments only and is not intended to be limiting of the present disclosure. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof. In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operation in a similar manner, and achieve a similar result.

### First Embodiment

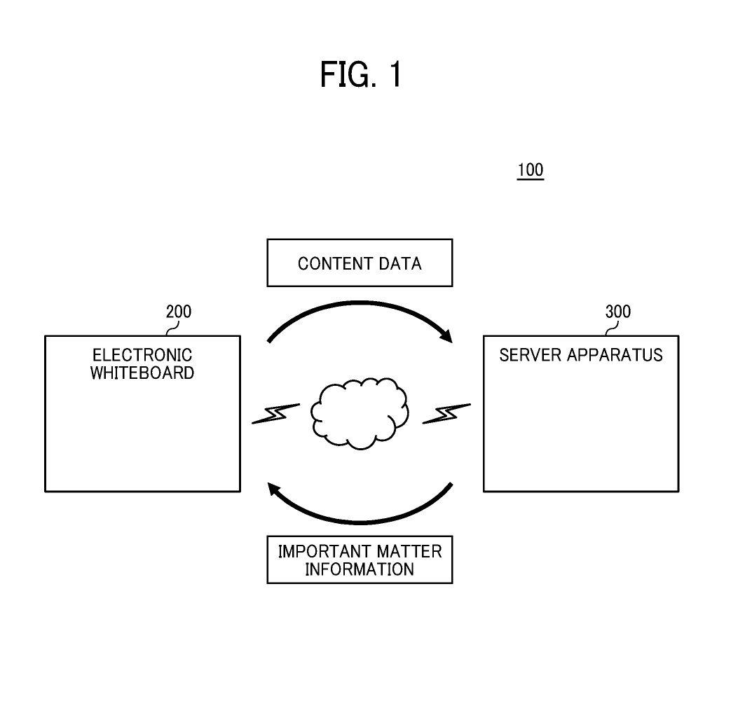

A description is given below of a first embodiment of the present disclosure, with reference to drawings. FIG. 1 is a schematic view illustrating an example of a configuration of an information processing system 100 according to the first embodiment.

The information processing system 100 according to the present embodiment includes an electronic whiteboard (electronic information board) 200 and a server apparatus 300. In the information processing system 100, the electronic whiteboard 200 and the server apparatus 300 are connected to each other via a network such as the Internet.

In the information processing system 100 according to the present embodiment, the electronic whiteboard 200 acquires image data (captured image data), stroke image data, and audio data. The image data is acquired by capturing a screen of the electronic whiteboard 200. The stroke image data indicates one or more characters, images, etc. that are manually drawn, or written, (drawn, or written by hand or using an electronic pen) on the electronic whiteboard 200. The audio data is acquired by collecting sound using a sound collecting device such as a microphone, etc. The image data acquired by capturing the screen of the electronic whiteboard 200 may be referred to as captured image data. The electronic whiteboard 200, then, transmits the captured image data, the stroke image data, and the audio data to the server apparatus 300. The electronic whiteboard 200 according to the present embodiment may associate each of the captured image data, the stroke image data, and the audio data with date and time information indicating when corresponding data is acquired, and then transmit the date and time information associated with the corresponding data to the server apparatus 300.

In addition, the electronic whiteboard 200 can communicate with a plurality of terminal apparatuses and acquire image data or audio data from each of the plurality of terminal apparatuses. When communicating with the plurality of terminal apparatuses, the electronic whiteboard 200 may share an image displayed on a screen of the electronic whiteboard 200 with the plurality of terminal apparatuses. When sharing an image displayed on the screen of the electronic whiteboard 200, the electronic whiteboard 200 is a shared terminal that is displaying an image being shared with the plurality of terminal apparatuses.

In the following description, data, which includes various types of data or information, acquired by the electronic whiteboard 200 and transmitted to the server apparatus 300 is referred to as content data, and each of the various types of data is referred to as a content data item. The content data according to the present embodiment include audio data, captured image data, which is obtained by capturing a screen of the electronic whiteboard 200, stroke image data, which is an input (hereinafter, also referred to as a handwriting input) made by manually drawing, stroke information that indicates a stroke image, video image data, and date and time information, which indicates when each of various types of data or information is received.

In the following description of the present embodiment, the stroke image data is defined as image data indicated by a group of points indicating a trajectory of a single stroke made by a user input that is a handwriting input on a touch panel. In addition, the stroke image is defined as an image that is drawn (displayed) on the display of the electronic whiteboard 200 based on the stroke image data.

The stroke information according to the present embodiment is defined as information in a vector format in which a stroke image is represented as numerical values or expressions. A detailed description of the stroke information is deferred.

When the electronic whiteboard 200 according to the present embodiment is used in a meeting, namely a remote meeting (teleconference), the electronic whiteboard 200 may associate information specifying a meeting name of the meeting with content data that is a set of content data items acquired by the electronic whiteboard 200 during the meeting and transmit the information and the content data items associated with each other to the server apparatus 300.

The server apparatus 300 according to the present embodiment stores the received content data. The server apparatus 300 may store the content data acquired from the electronic whiteboard 200 for each meeting. In addition, the electronic whiteboard 200 according to the present embodiment may perform a voice operation that is performed by receiving an operation instruction (command) based on voice data using a voice recognition function included in the server apparatus 300.

The audio data according to the present embodiment is defined as data obtained by digitizing a waveform indicating all sound that are collected by the sound collecting device. All the sound, mentioned above, includes voice of a person who speaks in proximity to the electronic whiteboard 200 and any sound other than such voice. Accordingly, in the following description of the present embodiment, voice data of voice of a person who speaks in proximity to the electronic whiteboard 200 is included in the audio data, namely the voice data is a part of the audio data.

In addition, the server apparatus 300 according to the present embodiment extracts, from the content data received from the electronic whiteboard 200, important matter information indicating an important matter in a meeting carried out using the electronic whiteboard 200.

In the example embodiment described here, it is assumed that the user inputs, by manually drawing or writing, a certain mark, or the like, on a screen displayed by the electronic whiteboard 200, for a part that the user regards as important. In other words, in the present embodiment, when a captured image of a screen displayed by the electronic whiteboard 200 includes a stroke image that is a handwriting input made by the user, the captured image may be regarded as being include an important matter.

In other words, a content data item (captured image data) that includes stroke information indicating a stroke image may include an important matter that is a matter regarded as being important by the user.

Accordingly, the electronic whiteboard 200 according to the present embodiment selects, as target data to be analyzed for extracting an important matter, a content data item that includes the stroke information among all the content data items acquired by the electronic whiteboard 200, if there is any, and transmits the selected content data item to the server apparatus 300.

The server apparatus 300 extracts image data in a region indicated by a stroke image drawn by a specific attribute from the content data item received from the electronic whiteboard 200. Then, the server apparatus 300 stores the extracted image data as important matter information.

In addition, when receiving a display request to display important matter information from the electronic whiteboard 200, the server apparatus 300 according to the present embodiment may cause the electronic whiteboard 200 to display the important matter information

As described above, the electronic whiteboard 200 according to the present embodiment transmits a content data item (captured image data) that includes the stroke information to the server apparatus 300, but not a content data item (captured image data) that does not include the stroke information.

Accordingly, the server apparatus 300 processes the content data item that includes stroke information to extract important matter information. In other words, the server apparatus 300 processes only the content data item that includes stroke information to detect a stroke image drawn by a specific attribute indicating important matter information. When a stroke image drawn by a specific attribute is detected, the server apparatus 300 extracts image data in a region specified by the detected stroke image as important matter information.

As described above, in the information processing system 100 according to the present embodiment, the process of extracting important matter information (specific information) does not required to be performed on all the content data items recorded by the electronic whiteboard 200, resulting in reduction of the processing load incurred by performing the process of extracting the important matter information. Therefore, the information processing system 100 according to the present embodiment shortens the time required for extracting the important matter information.

In addition, the electronic whiteboard 200 according to the present embodiment transmits only the content data item that includes stroke information to the server apparatus 300, resulting in reduction of the communication load incurred between the electronic whiteboard 200 and the server apparatus 300.

In the following description, receiving a handwriting input to the electronic whiteboard 200 is expressed as “receiving an input of stroke image”. That is, in the following description, a stroke image is being input from when the electronic whiteboard 200 detects a contact of a user's hand or an electronic pen onto the display until when the electronic whiteboard 200 detects that the user's hand or the electronic pen is made apart from the display.

In the present embodiment, by extracting the important matter information from the content data item and storing the important matter information, the electronic whiteboard 200 being used in the meeting can promptly display important matters that have been decided in the meeting, and the participants of the meeting can sees the screen displaying the important matters at a desired time during the meeting, for example, at a time before closing the meeting.

In other words, the server apparatus 300 according to the present embodiment provides a service of extracting important matter information from the content data item transmitted from the electronic whiteboard 200 and providing the extracted important matter information to the electronic whiteboard 200.

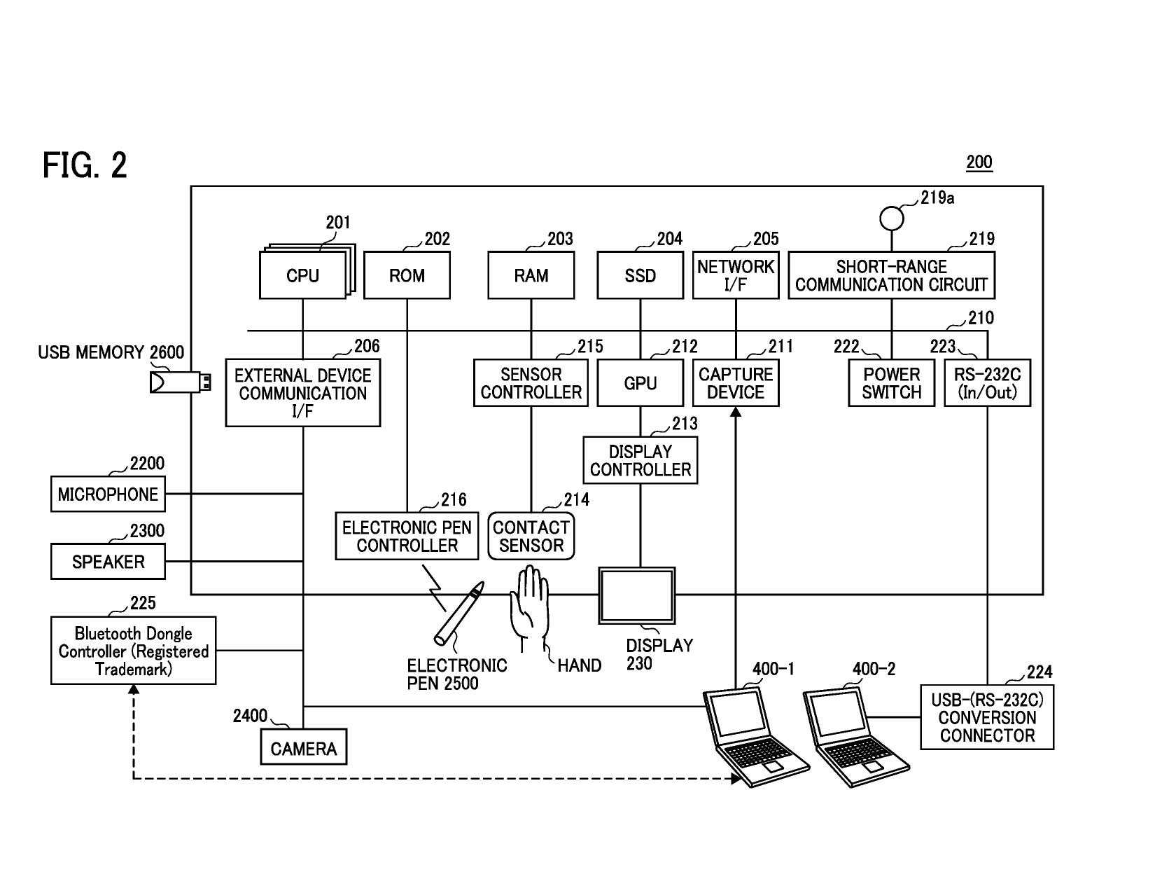

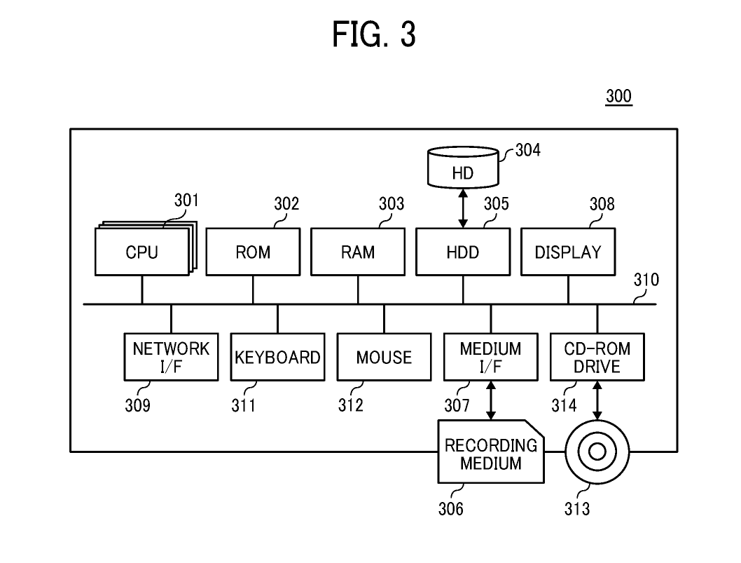

A description is now given of a hardware configuration of each apparatus included in the information processing system 100 according to the present embodiment, with reference to FIG. 2 and FIG. 3. FIG. 2 is a block diagram illustrating an example of a hardware configuration of the electronic whiteboard 200 according to the present embodiment.

As illustrated in FIG. 2, the electronic whiteboard 200 is a terminal apparatus that includes a central processing unit (CPU) 201, a read only memory (ROM) 202, a random-access memory (RAM) 203, a solid-state drive (SSD) 204, a network interface (I/F) 205, and an external device connection interface (I/F) 206.

The CPU 201 controls the overall operation of the electronic whiteboard 200. For example, the CPU 201 may include a plurality of CPUs.

The ROM 202 stores a control program for operating the CPU 201 such as an Initial Program Loader (IPL). The RAM 203 is used as a work area for the CPU 201. The SSD 204 stores various data such as a control program for an electronic whiteboard. The network I/F 205 controls communication with a communication network. The external device connection I/F 206 controls communication with a universal serial bus (USB) memory 2600 and other external devices including a camera 2400, a speaker 2300, and a microphone 2200, for example.

The electronic whiteboard 200 further includes a capturing device 211, a graphics processing unit (GPU) 212, a display controller 213, a contact sensor 214, a sensor controller 215, an electronic pen controller 216, a short-range communication circuit 219, an antenna 219a for the short-range communication circuit 219, and a power switch 222.

The capturing device 211 causes a display of a personal computer (PC) 400-1 to display a still image or a video image based on image data. The GPU 212 is a semiconductor chip dedicated to graphics. The display controller 213 outputs to a display 230 (display device) an image input from the GPU 212, namely manages images to be displayed. The contact sensor 214 detects a contact onto the display 230 with an electronic pen 2500 or a user's hand H.

The sensor controller 215 controls the contact sensor 214. The contact sensor 214 inputs and senses a coordinate by an infrared blocking system. More specifically, the display 230 is provided with two light receiving elements disposed on both upper side ends of the display 230, and a reflector frame disposed at the sides of the display 230. The light receiving elements emit a plurality of infrared rays in parallel to a surface of the display 230. The light receiving elements receive lights passing in the direction that is the same as an optical path of the emitted infrared rays, which are reflected by the reflector frame. The contact sensor 214 outputs an identifier (ID) of the infrared ray that is blocked by an object after being emitted from the two light receiving elements, to the sensor controller 215. Based on the ID of the infrared ray, the sensor controller 215 detects a specific coordinate that is touched by the object.

The electronic pen controller 216 communicates with the electronic pen 2500 to detect a contact with the top or bottom of the electronic pen 2500 on the display 230. The short-range communication circuit 219 is a communication circuit that communicates in compliance with the near field communication (NFC), the Bluetooth (registered trademark) or the like.

The power switch 222 is a switch that turns on or off the power of the electronic whiteboard 200.

The electronic whiteboard 200 also includes a bus line 210. The bus line 210 is an address bus or a data bus that electrically connects the hardware resources illustrated in FIG. 2, such as the CPU 201, to each other.

The electronic whiteboard 200 further includes an Recommended Standard 232 version C (RS-232C) port 223, a conversion connector 224, and a Bluetooth controller 225.

The RS-232C port 223 is connected to the bus line 210, and connects the PC 400-2 to the CPU 201, for example. The conversion connector 224 is a connector that connects the electronic whiteboard 200 to a USB port of the PC 400-2.

The Bluetooth controller 225 is, for example, a controller that enable the electronic whiteboard 200 to communicate with the PC 400-1, etc., using the Bluetooth.

The contact sensor 214 is not limited to the infrared blocking system type, and may be a different type of detector, such as a capacitance touch panel that identifies a contact position by detecting a change in capacitance, a resistance film touch panel that identifies a contact position by detecting a change in voltage of two opposed resistance films, or an electromagnetic induction touch panel that identifies a contact position by detecting electromagnetic induction caused by contact of an object to a display. In addition, or in alternative to detecting a touch by the tip or bottom of the electronic pen 2500, the electronic pen controller 216 may also detect a touch by another part of the electronic pen 2500, such as a part held by a hand of the user.

A description is now given of a hardware configuration of the server apparatus 300 according to the present embodiment, with reference to FIG. 3. FIG. 3 is a block diagram illustrating an example of a hardware configuration of the server apparatus 300.

The server apparatus 300 is constituted as a computer. As illustrated in FIG. 3, the server apparatus 300 is an information processing apparatus that includes a CPU 301, a ROM 302, a RAM 303, a hard disk (HD) 304, a hard disc drive (HDD) 305, a recording medium 306, a medium I/F 307, a display 308, a network I/F 309, a keyboard 311, a mouse 312, a compact-disc read only memory (CD-ROM) drive 314, and a bus line 310.

The CPU 301 controls the overall operation of the server apparatus 300. In the present embodiment, the CPU 301 may include a plurality of CPUs.

The ROM 302 stores a control program such as an IPL used for operating the CPU 301. The RAM 303 is used as a work area for the CPU 301. The HD 304 stores various data such as a program. The HDD 305 controls reading and writing of data from and to the HD 304 under control of the CPU 301. The medium I/F 307 controls reading or writing (storing) of data with respect to a recording medium 306 such as a flash memory. The display 308 displays various information such as a cursor, a menu, a window, a character, or an image. The network I/F 309 is an interface that transmits or receives data via a communication network. The keyboard 311 is an input device that is provided with a plurality of keys for enabling a user to input characters, numerals, or various instructions. The mouse 312 is another input device that enables a user to select a specific instruction or execution, select a target for processing, or move a cursor being displayed. The CD-ROM drive 314 reads or writes various data to or from a CD-ROM 313, which is an example of a removable recording medium.

The server apparatus 300 further includes a bus line 310. The bus line 310 is an address bus or a data bus, which electrically connects the hardware resources illustrated in FIG. 3 such as the CPU 301.

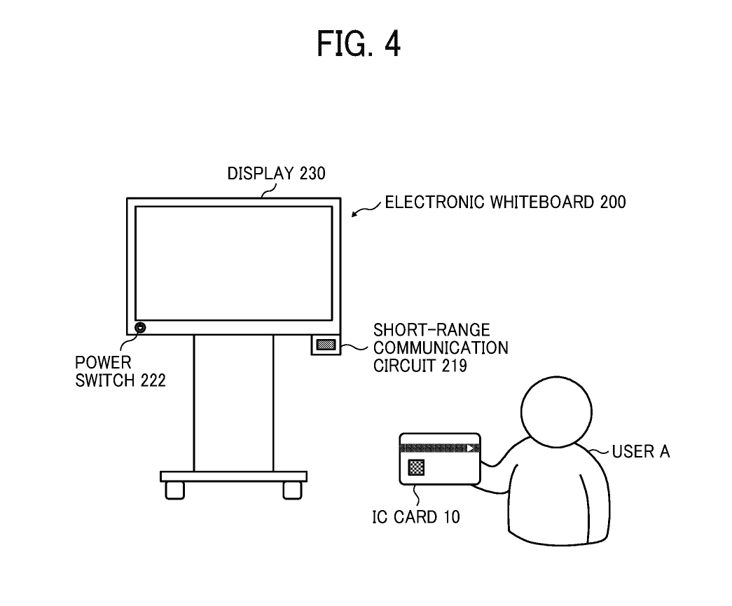

A description is now given of a use scenario of the electronic whiteboard 200 according to the present embodiment, with reference to FIG. 4. FIG. 4 is an illustration for explaining the use scenario of the electronic whiteboard 200.

In the example, a user A uses the electronic whiteboard 200. When the user A presses the power switch 222, a display control unit, which is described later, causes the display 230 to display a login screen. Then, when the user A brings his or her integrated circuit (IC) card 10 close to the short-range communication circuit 219 of the electronic whiteboard 200, the electronic whiteboard 200 reads identification information of the IC card 10 from the IC card 10. Then, the electronic whiteboard 200 transmits an authentication request for authenticating the IC card 10 to the server apparatus 300. The authentication request includes the identification information of the IC card 10. Then, upon receiving, from the server apparatus 300, a notification indicating that the user A is authenticated, the electronic whiteboard 200 stores, in the server apparatus 300, data input by the user A in association with the identification information of the IC card 10.

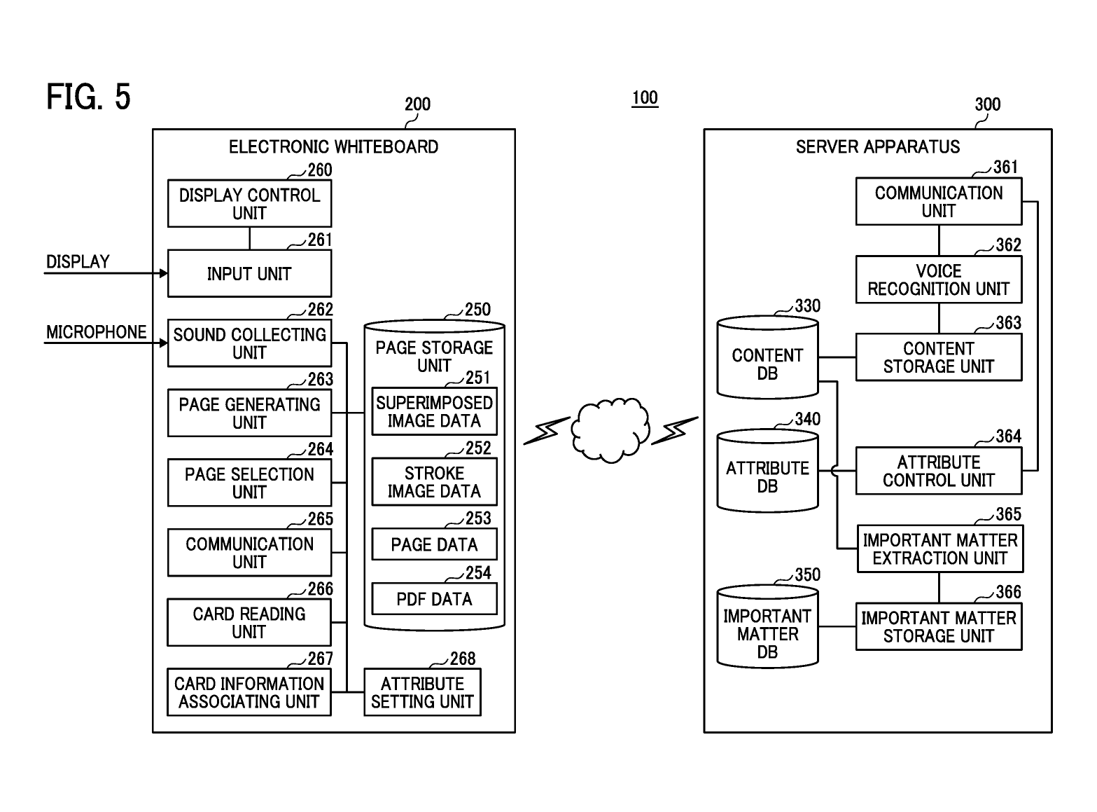

A description is now given of functions of each apparatus included in the information processing system 100, with reference to FIG. 5. FIG. 5 is schematic diagram illustrating functions of each apparatus included in the information processing system 100, according to the first embodiment.

First, a description is given of functions of the electronic whiteboard 200. The functional units of the electronic whiteboard 200 described below are implemented by the one or more CPUs 201 of the electronic whiteboard 200 executing a program loaded from the ROM 202, etc.

The electronic whiteboard 200 according to the present embodiment includes a page storage unit 250, a display control unit 260, an input unit 261, a sound collecting unit 262, a page generating unit 263, a page selection unit 264, a communication unit 265, a card reading unit 266, a card information associating unit 267 and an attribute setting unit 268.

The page storage unit 250 according to the present embodiment stores various types of data acquired by the processing performed by the page generating unit 263. More specifically, the page storage unit 250 stores, for example, superimposed image data 251, stroke image data 252, page data 253, portable document format (PDF) data 254. A detailed description of each type of data is deferred. The page storage unit 250 according to the present embodiment may be implemented, for example, with the SSD 204 of the electronic whiteboard 200.

The display control unit 260 according to the present embodiment causes the display 230 to display an image or video image that is output from a computer connected to the electronic whiteboard 200, various types of files that are input to the electronic whiteboard 200, and an image displayed on another electronic whiteboard 200 provided in a remote place. In addition, the display control unit 260 according to the present embodiment causes the display 230 to display a stroke image according to attribute information received from the server apparatus 300.

The input unit 261 according to the present embodiment acquires image data of stroke image indicating one or more characters and/or one or more images input by manually drawing on the display 230 by the user, and/or image data of one or more images displayed on a touch panel that mounted on the display 230.

In addition, the input unit 261 acquires video image data captured by the camera 2400. In the present embodiment, the image data includes the video image data. In addition, the input unit 261 receives various types of instructions to the electronic whiteboard 200. The input unit 261 further acquires input image data that is output from the PC 400-2 and input to the electronic whiteboard 200.

The sound collecting unit 262 according to the present embodiment acquires, as audio data, sound that is input to the microphone 2200. In addition, the sound collecting unit 262 acquires audio data that is input together with an image including a video image.

The page generating unit 263 according to the present embodiment acquires the superimposed image data 251, the page data 253, and the PDF data 254 from an image (display image) of one page displayed on the display 230. In addition, the page generating unit 263 acquires the stroke image data 252 when a stroke image is input and added to the image of one page.

More specifically, the page generating unit 263 acquires image data of a superimposed image obtained by superimposing an input image, a stroke image, and the like input to the display 230, and stores the superimposed image in the page storage unit 250 as the superimposed image data 251. When a stroke image is not input to the display 230, the page generating unit 263 sets the image displayed on the display 230 as superimposed image data.

In the present embodiment, the superimposed image is a captured image obtained by capturing a screen of the display 230 and the superimposed image data is identical with captured image data. In other words, the superimposed image is a display image displayed on the screen of the display 230, and the superimposed image data is display image data of the display image displayed on a screen of the display 230.

The page generating unit 263 further acquires image data of stroke image when a stroke image is input on the display 230 and stores the image data of stroke image in the page storage unit 250 as the stroke image data 252.

The page generating unit 263 further generates page data for displaying an image displayed on the display 230 based on the image and stores the page data in the page storage unit 250 as the page data 253. A detailed description of the page data 253 is deferred.

The page generating unit 263 further generates the PDF data 254 obtained by converting the superimposed image data 251 into a PDF based on the superimposed image data 251, the stroke image data 252, and the page data 253 and stores the PDF data 254 in the page storage unit 250.

As described above, the page generating unit 263 according to the present embodiment is a generating unit that generates a content data item based on display image data displayed on the display 230.

In the present embodiment, when superimposed image data includes stroke image data, the PDF data 254 includes image data in a Portable Network Graphics (PNG) format generated based on the superimposed image data and stroke information in a vector format generated based on page data. In the present embodiment, when superimposed image data does not include stroke image data, the PDF data 254 includes only image data in a PNG format. A detailed description of the PDF data 254 is deferred.

In the present embodiment, the superimposed image data 251 includes, for example, page identification information (page ID) for identifying a page, and the superimposed image data 251, the stroke image data 252, the page data 253, and the PDF data 254 are associated with each other using the page ID.

In the present embodiment, among the data stored in the page storage unit 250, the superimposed image data 251, the stroke image data 252, and the PDF data 254, namely the data stored in the page storage unit 250 except for the page data 253, may be transmitted to the server apparatus 300 as a part of the content data. In addition, in the present embodiment, the data stored in the page storage unit 250 may be transmitted to the server apparatus 300 as a part of the content data.

The page selection unit 264 selects PDF data that includes stroke information from the PDF data 254 generated by the page generating unit 263. In addition, the page selection unit 264 causes the communication unit 265 to transmit the selected PDF data to the server apparatus 300.

That is, in the present embodiment, the stroke information included in the content data item is stroke information in a vector format included in the PDF data 254. In other words, in the present embodiment, the content data item selected by a determination of the presence of stroke information is the PDF data 254. Therefore, the page selection unit 264 according to the present embodiment is a selection unit that selects content data item that includes stroke information.

The communication unit 265 according to the present embodiment transmits, to the server apparatus 300, content data including the above-described various types of data, received by the input unit 261, the audio data acquired by the sound collecting unit 262, and the PDF data 254 selected by the page selection unit 264.

The card reading unit 266 according to the present embodiment reads identification information (card ID) recorded on the IC card 10 when the IC card 10 is held over or near the antenna 219a. In the present embodiment, the card ID is, for example, card identification information identifying an owner of the IC card 10 (a user of the electronic whiteboard 200).

The card information associating unit 267 associates the card ID read by the card reading unit 266 with the content data. More specifically, the card information associating unit 267 may associate the content data acquired within a given period of time after the card reading unit 266 reads the card ID with the read card ID, for example.

Thus, according to the present embodiment, the content data including characters, images or sound can be associated with a participant who previously inputs the content data, before the participant starts verbally communicating or drawing characters or numbers, for example, by holding his or her own IC card 10 over or near the antenna 219a.

When transmitting the content data, the communication unit 265 according to the present embodiment transmits the content data item together with the card ID associated with the content data to the server apparatus 300.

The attribute setting unit 268 according to the present embodiment receives specific attribute information from the server apparatus 300 and sets the specific attribute information to stroke image data that is data of a target stroke image of which the attribute is to be changed based on an attribute change instruction.

In the present embodiment, the specific attribute information is also identification information indicating that the stroke image is an image specifying an important matter. In addition, in the present embodiment, the attribute change instruction may be, for example, an operation of touching a predetermined position on the display 230 or drawing a stroke image that has a specific shape determined in advance.

A description is now given of functions of the server apparatus 300 according to the present embodiment. The server apparatus 300 according to the present embodiment includes a content database 330, an attribute database 340, and an important matter database 350. In FIG. 5, the above-mentioned databases are provided in the server apparatus 300, however the embodiments of the disclosure are not limited to this configuration. For example, one or more of these databases may be provided in an external storage device being external to the server apparatus 300.

The server apparatus 300 according to the present embodiment further includes a communication unit 361, a voice recognition unit 362, a content storage unit 363, an attribute control unit 364, an important matter extraction unit 365, and an important matter storage unit 366. Each functional unit of the server apparatus 300 according to the present embodiment is implemented by the one or more CPUs 301 of the server apparatus 300 executing a program loaded from the ROM 302.

The content database 330 stores various types of data (content data, i.e., content data items) received from the electronic whiteboard 200. The attribute database 340 stores information on various types of attributes that are to be set to a stroke image. The attribute information is information indicating, for example, a color of a stroke image, a thickness of a line, etc. The important matter database 350 stores important matter information extracted by the important matter extraction unit 365. A detailed description of each of the above-described databases is deferred.

The communication unit 361 according to the present embodiment establishes communication between the server apparatus 300 and another apparatus. More specifically, the communication unit 361 of the server apparatus 300 transmits and receives information to and from the electronic whiteboard 200.

The voice recognition unit 362 according to the present embodiment converts audio data included in the content data into text data using voice recognition function. The voice recognition function of the voice recognition unit 362 can be implemented by artificial intelligence, for example.

In response to receiving content data at the communication unit 361, the content storage unit 363 according to the present embodiment stores the received content data in the content database 330.

When the communication unit 361 receives an attribute change instruction to change the attribute of the stroke image from the electronic whiteboard 200, the attribute control unit 364 transfers specific attribute information stored in advance to the communication unit 361 and causes the communication unit 361 to transmit the specific attribute information to the electronic whiteboard 200. The specific attribute information sorted in advance by the attribute control unit 364 is information on a specific attribute that indicates an important matter.

In addition, upon receiving, from the electronic whiteboard 200, a request for setting attribute information, the attribute control unit 364 according to the present embodiment causes the display 230 of the electronic whiteboard 200 to display a list of the attributes stored in the attribute database 340. Subsequently, the attribute control unit 364 may retain attribute information indicating the attributes selected by the electronic whiteboard 200 as specific attribute information.

The important matter extraction unit 365 extracts important matter information from the content data received from the electronic whiteboard 200. More specifically, the important matter extraction unit 365 detects stroke image data, to which the specific attribute information is set, from the image data in the PNG format included in the PDF data 254 selected by the page selection unit 264, and extracts image data in a region surrounded by the detected stroke image data as the important matter information.

The important matter storage unit 366 stores the important matter information extracted by the important matter extraction unit 365 in the important matter database 350. When storing the important matter information, the important matter storage unit 366 according to the present embodiment may store the important matter information in association with date and time information indicating a data and time at which the PDF data from which the important matter information is extracted is acquired or in association with a name of a meeting corresponding to the PDF data, for example.

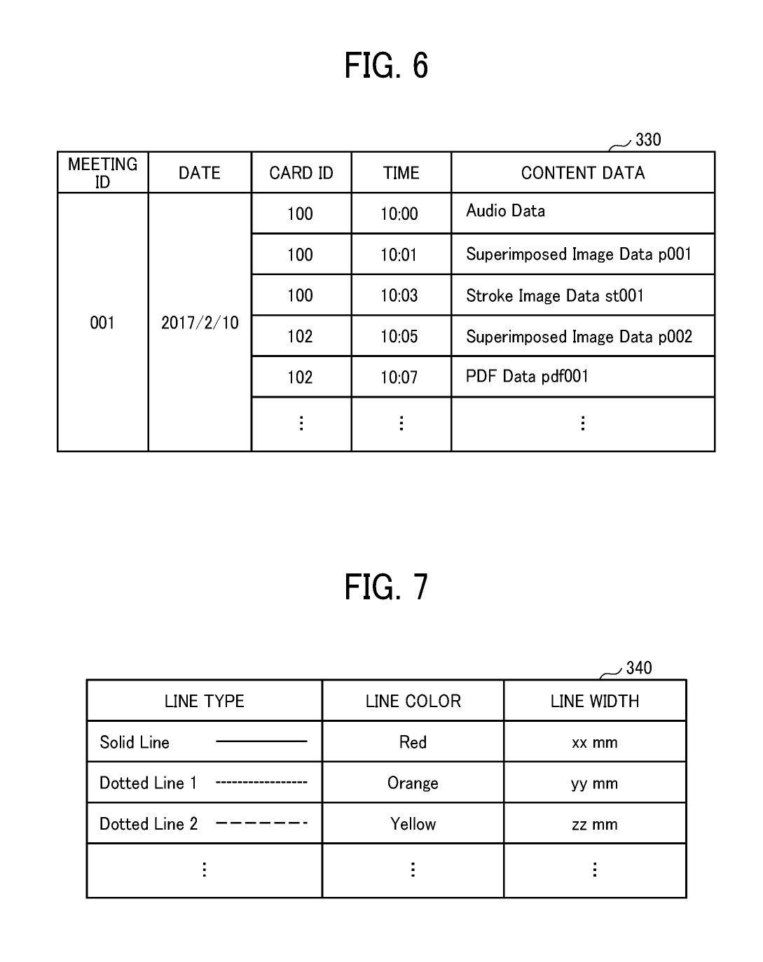

A description is now given of each database included in the server apparatus 300 according to the present embodiment, with reference to FIG. 6 to FIG. 8. FIG. 6 is a conceptual diagram illustrating an example of the content database 330, according to the first embodiment.

The content database 330 according to the present embodiment includes items of “meeting ID”, “date”, “card ID”, “time”, and “content data”.

The item of “meeting ID” is identification information for identifying a meeting being held using the electronic whiteboard 200. The item of “date” indicates a date on which a meeting identified by the associated meeting ID is held. The item of “card ID” indicates card identification information stored in an IC card. The item of “time” indicates a time at which associated content data item is acquired. The item of “content data” is content data item that is received from the electronic whiteboard 200.

In the example of FIG. 6, the electronic whiteboard 200 acquires audio data associated with the card ID of “100” at 10:00 in a meeting identified by the meeting ID of “001” and held on Feb. 10, 2017. In addition, the electronic whiteboard 200 acquires superimposed image data p001 that is associated with the card ID of “100”, at 10:01. Furthermore, the electronic whiteboard 200 acquires stroke image data st001 that is associated with the card ID of “100” at 10:03.

In some embodiments, the content database 330 may store text data obtained by converting audio data by the voice recognition unit 362, and the text data may be stored in the HD 304 or the like. In some embodiments, the content database 330 may include a meeting name associated with a corresponding meeting ID.

FIG. 7 is a conceptual diagram illustrating an example of the attribute database 340, according to the first embodiment. The attribute database 340 according to the present embodiment includes items of “line type”, “line color”, and “line width”, which are associated with each other. In addition, “line” in the attribute database 340 illustrated in FIG. 7 includes a straight line and a curved line, indicating an image of a single stroke, which is a stroke image. In other words, in the present embodiment, a term of “line”, and a term of “stroke image” are interchangeable terms.

The item of “line type” indicates a type of line. The item of “line color” indicates a color of line. The item of “line width” indicates a thickness of line.

The example of FIG. 7 indicates that there are line types including, at least, a solid line, a dotted line 1, and a dotted line 2. In addition, the example of FIG. 7 indicates that there are line colors, at least, including red, orange, and yellow. Furthermore, the example of FIG. 7 indicates that there are line widths including, at least, xx mm, yy mm, and zz mm.

In the following description, information including the above-described items included in the attribute database 340 and values of the items are referred to as attribute information.

A description is now given of setting attribute information stored in the attribute control unit 364 according to the present embodiment. In the information processing system 100 according to the present embodiment, when the input unit 261 receives a request for setting attribute information to a stroke image, the electronic whiteboard 200 transmits a setting request to the server apparatus 300. When the communication unit 361 receives the setting request, the attribute control unit 364 of the server apparatus 300 causes the electronic whiteboard 200 to display a screen for selecting attributes from the attribute information stored in the attribute database 340.

The screen for selecting attributes is, for example, a screen for setting a value for each of the items included in the attribute database 340.

When a value is selected for each of the items of “line type”, “line color”, and “line width” on the screen displayed on the display 230, the attribute setting unit 268 of the electronic whiteboard 200 transmits, to the server apparatus 300, a notification indicating the value selected for each of the items.

In response to the notification, the attribute control unit 364 of the server apparatus 300 stores, as the attribute information, the value selected for each of the items. Accordingly, the attribute information stored in the attribute control unit 364 of the present embodiment is information indicating a line type, a line color, and a line width at a time a stroke image is drawn. For example, when the dotted line 1 is selected as a value for the item of “line type”, the orange is selected as a value for the item of “line color”, and 0.8 mm is selected as a value for the item of “line width” at the electronic whiteboard 200, the attribute information is “dotted line 1, orange, 0.8 mm”.

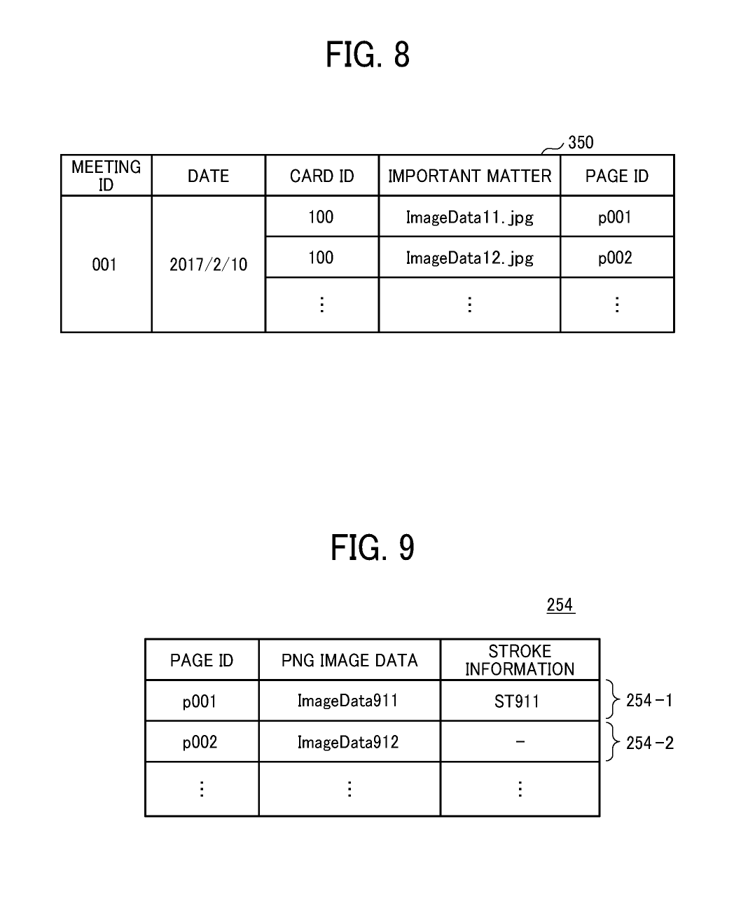

FIG. 8 is a conceptual diagram illustrating an example of the important matter database 350, according to the first embodiment. The important matter database 350 according to the present embodiment includes items of “meeting ID” “date”, “important matter”, and “page ID”, which are associated with each other. In the present embodiment, the important matter information may include the values for the items of “meeting ID”, “date”, “card ID”, “important matter”, and “page ID” in the important matter database 350.

The item of “date” indicates a date on which PDF data including the associated “important matter” is acquired. A value for the item of “important matter” indicates an important matter extracted from the superimposed image data. A value for the item of “page ID” is a page identification information for identifying the superimposed image data 251 including image data indicating an important matter.

The important matter database 350 may not need to include all the items illustrated in FIG. 8, as items of information as long as the important matter database 350 includes at least the item of “meeting ID” and the item of “important matter” as the items of information.

The example of FIG. 8 indicates that “ImageData11.jpg” associated with the card ID of “100” is extracted as an important matter, at a meeting identified by the meeting ID of “001” and held on Feb. 10, 2017.

The server apparatus 300 according to the present embodiment may include an optical character recognition (OCR) function and perform character recognition on an image indicated by image data extracted as the important matter information. The server apparatus 300 including the OCR function may add, in the important matter information, text data obtained through the character recognition performed on the image data. In the present embodiment, an important matter can be stored as text data by performing the character recognition as described above.

The information processing system 100 described above includes a single server apparatus 300, however the embodiments of the disclosure are not limited to this configuration. In some embodiments, the information processing system 100 includes a plurality of server apparatuses 300 and the above-described functions, and databases may be distributed over the plurality of server apparatuses 300. Furthermore, the information processing system 100 having a system configuration in which the electronic whiteboard 200 is connected to the server apparatus 300 so that the electronic whiteboard 200 and the server apparatus can establish communication is just an example. There are various types of system configurations that are different from each other depending on applications or purposes.

A description is now given of the PDF data 254 according to the embodiment, with reference to FIG. 9. FIG. 9 is a conceptual diagram illustrating a data structure of PDF data 254.

In the present embodiment, the PDF data 254 includes information items of “page ID”, “PNG image data (image data in a PNG format)”, and “stroke information”.

The image data in a PNG format is generated based on the superimposed image data. The stroke information is data in a vector format that is generated based on page data used for displaying the superimposed image data. The data in the vector format is data expressing information for generating a geometric figure as numerical values or expressions.

In addition, in the present embodiment, when the superimposed image does not include a stroke image, the PDF data is data including a page ID and image data in a PNG format.

In the PDF data 254 illustrated in FIG. 9, “ImageData911” in the PNG format and the stroke information ST 911 are associated with the page ID of “p001”. Accordingly, the superimposed image data identified by the page ID of “p001” includes the stroke image data. Therefore, the PDF data 254-1 associated with the page ID of “p001” is selected by the page selection unit 264.

In addition, in FIG. 9, the page ID of “p002” is associated with “ImageData912” in the PNG format, and there is no stroke information associated with. Accordingly, the superimposed image data identified by the page ID of “p002” does not include stroke image data. Therefore, the PDF data 254-2 of the page ID of “p002” is not selected by the page selection unit 264.

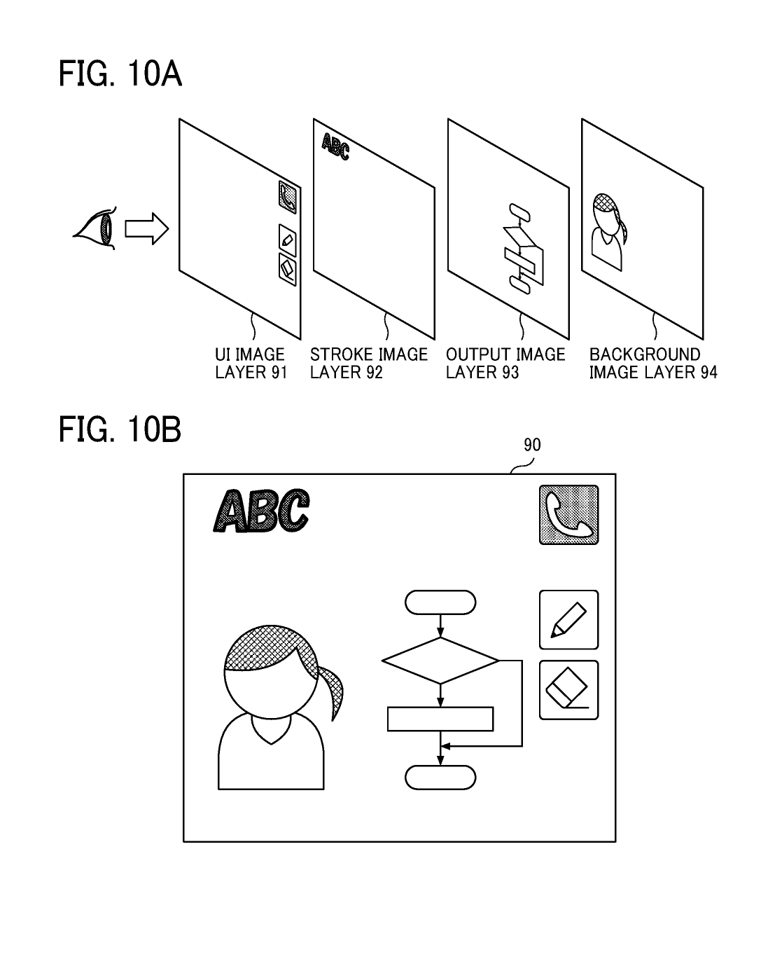

A description is now given of the page data, which is to be recorded, generated by the page generating unit 263 according to the present embodiment, with reference to FIG. 10 (FIG. 10A and FIG. 10B) to FIG. 14. At first, a screen displayed on the display 230 of the electronic whiteboard 200 according to the present embodiment is described.

The screen displayed on the display 230 of the electronic whiteboard 200 is described with reference to FIG. 10A and FIG. 10B. FIG. 10A is an illustration of images to be superimposed, according to the present embodiment. FIG. 10B is an illustration of a superimposed image, according to the present embodiment.

The display control unit 260 of the electronic whiteboard 200 causes the display 230 to display an input image acquired by the input unit 261, a stroke image, a user interface (UI) image, and a background image in a manner that the input image, the stroke image, the UI image, and the background image are superimposed according to a layout designated in advance.

The UI image is an image set in advance. In addition, the background image is, for example, a plain image, an image including a grid line, or the like, and is media data included in the superimposed image. A detailed description of the media data is deferred.

As illustrated in FIG. 10A, the display control unit 260 includes a layer for displaying a UI image (UI image layer) 91, a layer for displaying a stroke image (stroke image layer) 92, and a layer for displaying an input image that is output from a PC and input to the electronic whiteboard 200 (output image layer) 93, and a layer for di splaying a background image (background image layer) 94.

The display control unit 260 according to the present embodiment causes the layers to be superimposed in a manner that the layer 91, the layer 92, and the layer 93, the layer 94 are the first layer, the second layer, the third layer, and the fourth layer, respectively, when the display 230 is viewed by the user of the electronic whiteboard 200.

Then, the display control unit 260 synthesizes the image data of the UI image (UI image data), the stroke image data, the image data of the input image (input image data), and the image data of the background image (background image data), thereby generating image data of a superimposed image 90 of four layers.

That is, the superimposed image in the present embodiment is an image obtained by synthesizing images displayed on each of the layers of the display 230.

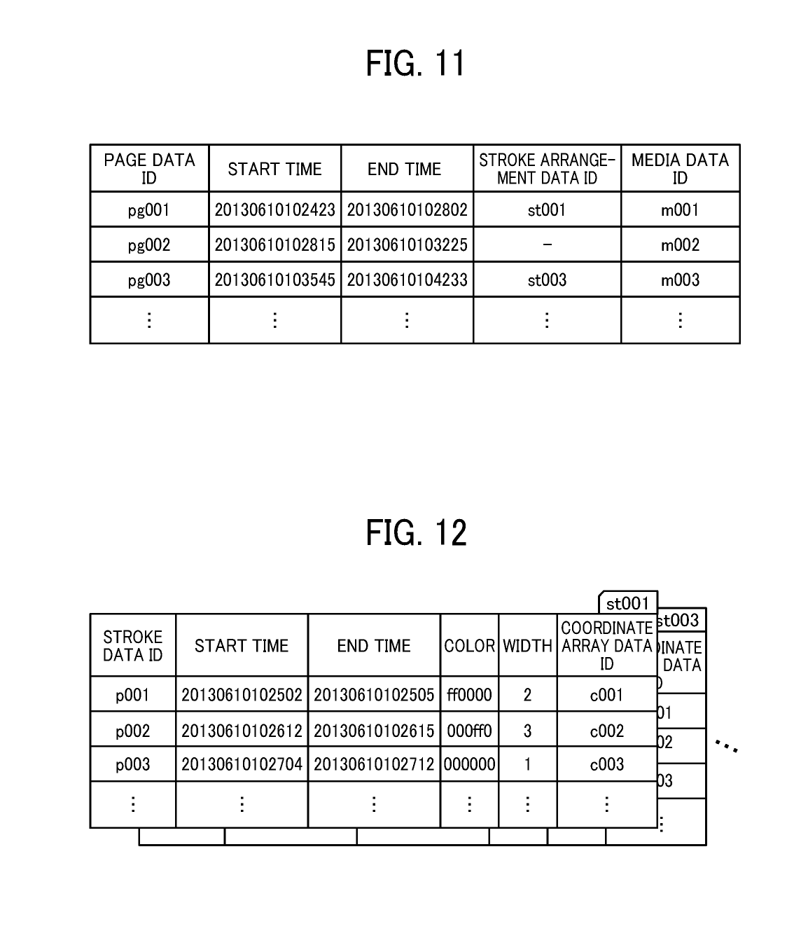

A description is now given of the page data according to the present embodiment, with reference to FIG. 11. FIG. 11 is a conceptual diagram illustrating the paged data according to the first embodiment.

The page generating unit 263 of the electronic whiteboard 200 according to the present embodiment may generate page data having a structure, as illustrated in FIG. 11, to be stored in the page storage unit 250.

The page data according to the present embodiment includes information items of “page data ID”, “start time”, “end time”, “stroke arrangement data ID”, and “media data ID”.

A value of the item of “start time” indicates a time at which a page is started to be displayed. A value of the item of “end time” indicates a time at which update of the page data is completed. A value of the item of “stroke arrangement data ID” indicates identification information for identifying stroke arrangement data generated by inputting a stroke image. In the present embodiment, the stroke arrangement data includes coordinate information on a group of points indicating a specific shape. That is, the stroke arrangement data according to the present embodiment is stroke information which is a group of points indicating a trajectory of a single stroke.

A value of the item of “media data ID” indicates identification information for identifying media data. The media data is data for displaying the background image on the display 230.

As described above, in the present embodiment, when the page data is saved, the stroke arrangement data for displaying the input stroke image on the display 230 is associated with the page data identified by the corresponding page data ID.

In addition, in the present embodiment, when a stroke image is not input, there is no stroke arrangement data to be associated with the page data, so that a field of the value of the item of “stroke arrangement data ID” in the page data is blank.

For example, in the example of FIG. 11, the page data ID of “pg001” is associated with the stroke arrangement data ID of “st001”. Accordingly, a stroke image is included in the superimposed image which is a source of the page data identified by the page data ID of “pg001”.

In the example of FIG. 11, there is no value of the stroke arrangement data ID input in association with the page data ID of “pg002”. Accordingly, a stroke image is not included in the superimposed image which is a source of the page data identified by the page data ID of “pg002”.

A description is now given of the stroke arrangement data according to the embodiment, with reference to FIG. 12. FIG. 12 is a conceptual diagram illustrating the stroke arrangement data according to the present embodiment.

The stroke arrangement data according to the present embodiment includes a plurality of records of stroke data. Each of the plurality of records of stroke data is generated each time when the user input a stroke image by manually drawing a stroke image. For example, when the user draws an alphabet letter of “S” that is drawn by a single stroke with the electronic pen 2500, the letter, namely “S”, is indicated by a single stroke data ID. Alternatively, for example, when the user draws an alphabet letter of “T” that is drawn by two strokes with the electronic pen 2500, the letter of “T” is indicated by two stroke data IDs.

The stroke arrangement data according to the present embodiment includes information items of “stroke data ID”, “start time”, “end time”, “color”, “width”, and “coordinate array data ID”.

The item of “stroke data ID” is identification information for identifying stroke data. A value of the item of “start time” indicates a time at which the user starts writing a stroke image. A value of the item of “end time” indicates a time at which the user finishes writing a stroke image.

A value of the item of “color” indicates a color of stroke, and a value of the item of “width” indicates a width of stroke. A value of the item of “coordinate array data ID” indicates identification information for identifying coordinate array data (group of coordinates) including information associated with points of stroke.

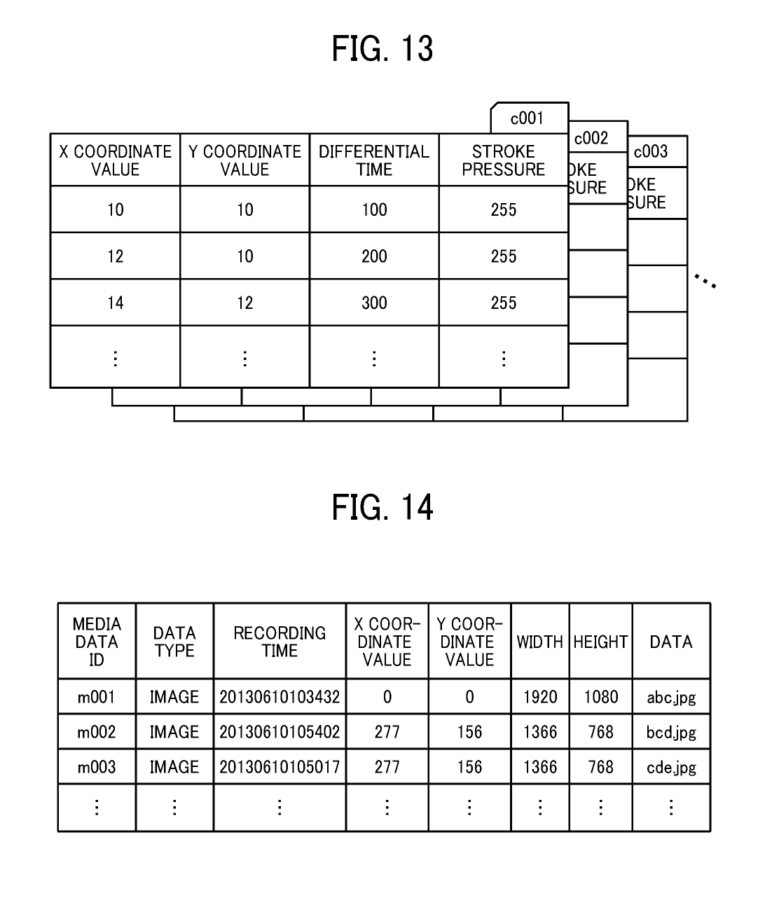

A description is now given of the coordinate array data according to the embodiment, with reference to FIG. 13. FIG. 13 is a conceptual diagram illustrating the coordinate array data according the present embodiment.

The coordinate array data according to the embodiment is provided for each coordinate array data ID. The coordinate array data according to the present embodiment includes information items of “X coordinate value”, “Y coordinate value”, “differential time”, and “stroke pressure”.

Values of the item of “X coordinate value” and the item of “Y coordinate” individually indicate a position indicating each point of a stroke image on the display 230. A value of the item of “differential time” indicates a difference between a time when a stroke passes on a value of “X coordinate” and a time when the stroke passes on a value of “Y coordinate”, from the time when the user starts writing the stroke image. A value of the item of “stroke pressure” indicates a drawing pressure made by the electronic pen 2500 or user's hand when a stroke image is drawn.

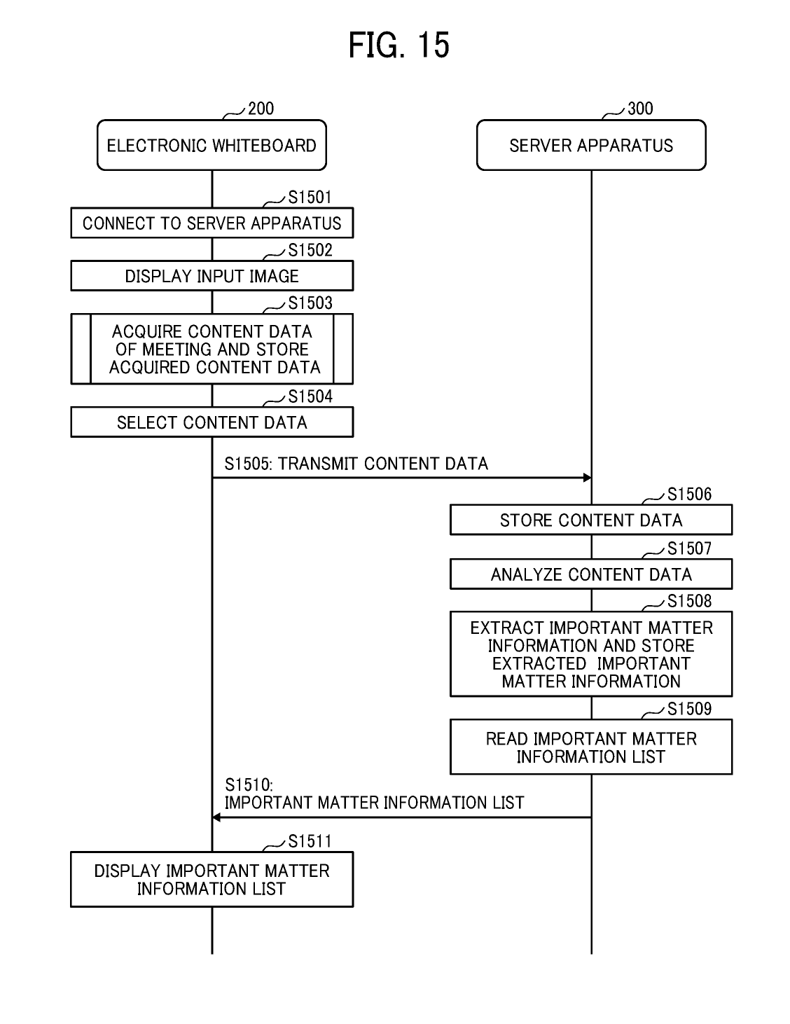

A description is now given of the media data according to the embodiment, with reference to FIG. 14. FIG. 14 is a diagram illustrating the media data, according to the embodiment.

The media data according to the present embodiment includes information items of “media data ID”, “data type”, “recording time”, “X coordinate value”, “Y coordinate value”, “width”, “height”, and “data”.

A value of the item of “media data ID” indicates identification information for identifying media data. The value of the item of “data type” indicates a type of media data. The value of the item of “recording time” indicates a time at which the page data is stored in the electronic whiteboard 200. A value of the item of “X coordinate value” and a value of the item of “Y coordinate value” indicate a position of the media data displayed on the display 230. More specifically, the values of the item of “X coordinate value” and the item of “Y coordinate value” individually indicate a position of upper left end of the media data, when a coordinate of the upper left end of the display 230 is used as a reference.

A value of the item of “width” and a value of the item of “height” indicate a size of media data. More specifically, the value of the item of “width” and the value of the item of “height” respectively indicate the width and height of an image when a type of the media data is an image. A value of the item of “data” indicates content of media data.

The page data according to the present embodiment is stored in the electronic whiteboard 200 as data having the above-described data structure.

A description is now given of a process performed by the information processing system 100 according to the present embodiment, with reference to FIG. 15. FIG. 15 is a sequence diagram illustrating the process performed by the information processing system 100 according to the first embodiment.

In the information processing system 100 according to the present embodiment, when the input unit 261 receives a connection request to connect to the server apparatus 300, the electronic whiteboard 200 connects to the server apparatus 300 by the communication unit 265 (step S1501). The connection request to connect to the server apparatus 300 may be, for example, an instruction to start a meeting using the information processing system 100.

Subsequently, the electronic whiteboard 200 displays an input image acquired by the input unit 261 from, for example, the PC400-2 on the display 230 by the display control unit 260 (step S1502).

Subsequently, in the electronic whiteboard 200, the page generating unit 263 generates content data (content data items) and stores the content data items in the page storage unit 250 (step S1503). A detailed description of S1503 is deferred.

Subsequently, in the electronic whiteboard 200, the page selection unit 264 selects a content data item that includes stroke information among all the content data items acquired by the page generating unit 263 during a period of time from when a first instruction that instruct to start the meeting is received to when a second instruction that instruct to end the meeting is received (step S1504).

In other words, the page selection unit 264 selects, PDF data that includes stroke information among the PDF data acquired during the period of time from when the first instruction to start the meeting is received to when the second instruction to end the meeting is received.

Subsequently, the communication unit 265 of the electronic whiteboard 200 transmits the content data item (PDF data) selected by the page selection unit 264 to the server apparatus 300 (step S1505).

When the communication unit 361 of the server apparatus 300 receives the page data, the content storage unit 363 of the server apparatus 300 stores the received content data item in the content database 330 (step S1506).

Subsequently, the important matter extraction unit 365 of the server apparatus 300 analyzes the received content data item (step S1507).

More specifically, the important matter extraction unit 365 of the server apparatus 300 detects whether the image data in the PNG format included in the received PDF data includes stroke image data to which the specific attribute information is set.

Subsequently, the important matter extraction unit 365 of the server apparatus 300 extracts the image data in a region designated by the detected stroke image as important matter information and causes the important matter storage unit 366 to store the extracted important matter information in the important matter database 350 (step S1508).

Subsequently, the communication unit 361 of the server apparatus 300 reads information indicating a list of the extracted important matter information (hereinafter, referred to as an important matter information list) (step S1509) and transmits the list to the electronic whiteboard 200 (step S1510).

When the communication unit 265 of the electronic whiteboard 200 receives the information indicating the important matter information list, the display control unit 260 causes the display 230 to display the information indicating the received important matter information list (step S1511), and the process is completed.

In FIG. 15, when the important matter information is extracted, the server apparatus 300 transmits the information indicating the important matter information list to the electronic whiteboard 200, but the embodiments of the disclosure are not limited to this configuration. For example, the server apparatus 300 may transmit information indicating the important matter information list to the electronic whiteboard 200 in response to a request for an important matter information list received from the electronic whiteboard 200.

As described above, in the present embodiment, when the stroke information is not included in the PDF data that is a part of the content data, the PDF data is excluded from the target data to be analyzed for extracting important matter information.

That is, in the present embodiment, the detection of the important matter information is performed on the content data item that includes the information input by manually drawing, namely input by a handwriting input of the user, but not the content data item that does not includes the information input by manually drawing, namely input by a handwriting input of the user.

Accordingly, in the present embodiment, the processing load incurred by extracting the important matter information can be reduced, and thereby shortening the time required to extract the important matter information and display the list on the electronic whiteboard 200.

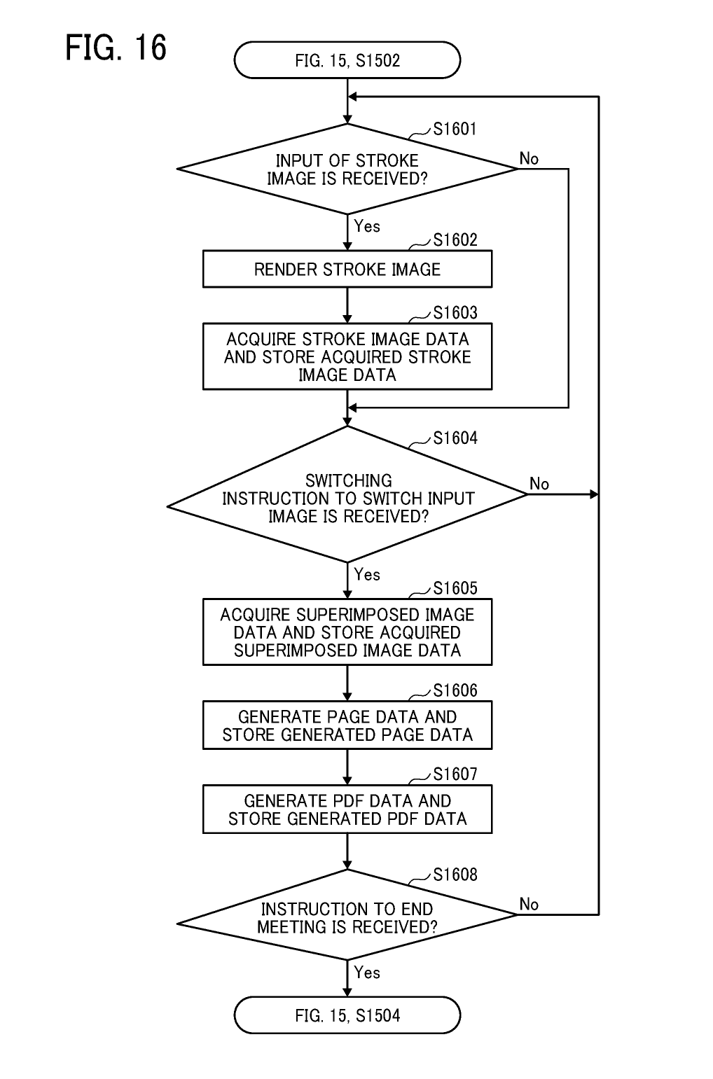

A description is now given of a process of recording page data performed by the electronic whiteboard 200 according to the present embodiment, with reference to FIG. 16. FIG. 16 is a flowchart illustrating an example of the process of recording the page data, according to the first embodiment. The process illustrated in FIG. 16 is details of the above-described step of S1503 illustrated in FIG. 15.

When the input image is displayed on the display 230 of the electronic whiteboard 200, a determination whether the input unit 261 receives an input of stroke image or not is made (step S1601). In S1601, when the input of stroke image is not received, the process performed by the electronic whiteboard 200 proceeds to a step of S1604 as described later.

On the other hand, when the input of stroke image is received in S1601, the display control unit 260 of the electronic whiteboard 200 renders a stroke image to display the stroke image, based on the input of stroked image (step S1602). Subsequently, the page generating unit 263 of the electronic whiteboard 200 acquires stroke image data indicating the stroke image and stores the stroke image data in the page storage unit 250 (step S1603).

Subsequently, a determination whether the input unit 261 of the electronic whiteboard 200 receives a switching instruction to switch an image displayed on the display or not 230 is made (step S1604). In S1604, when the input unit 261 does not receive the switching instruction, the process performed by the electronic whiteboard 200 returns to S1601.

In S1604, when the input unit 261 receives the switching instruction, the page generating unit 263 of the electronic whiteboard 200 acquires superimposed image data and stores the acquired superimposed image data in the page storage unit 250 (step S1605). Subsequently, the page generating unit 263 of the electronic whiteboard 200 generates page data and store the generated page data in the page storage unit 250 (step S1606). Subsequently, the page generating unit 263 of the electronic whiteboard 200 generates PDF data and store the generated PDF data in the page storage unit 250 (step S1607).

Subsequently, a determination whether the input unit 261 of the electronic whiteboard 200 receives an instruction to end the meeting or not is made (step S1608). In S1608, when the input unit 261 does not receive the instruction to end the meeting, the process performed by the electronic whiteboard 200 returns to S1601.

On the other hand, when the input unit 261 receives the instruction to end the meeting in S1608, the process performed by the electronic whiteboard 200 proceeds to S1504 illustrated in FIG. 15.

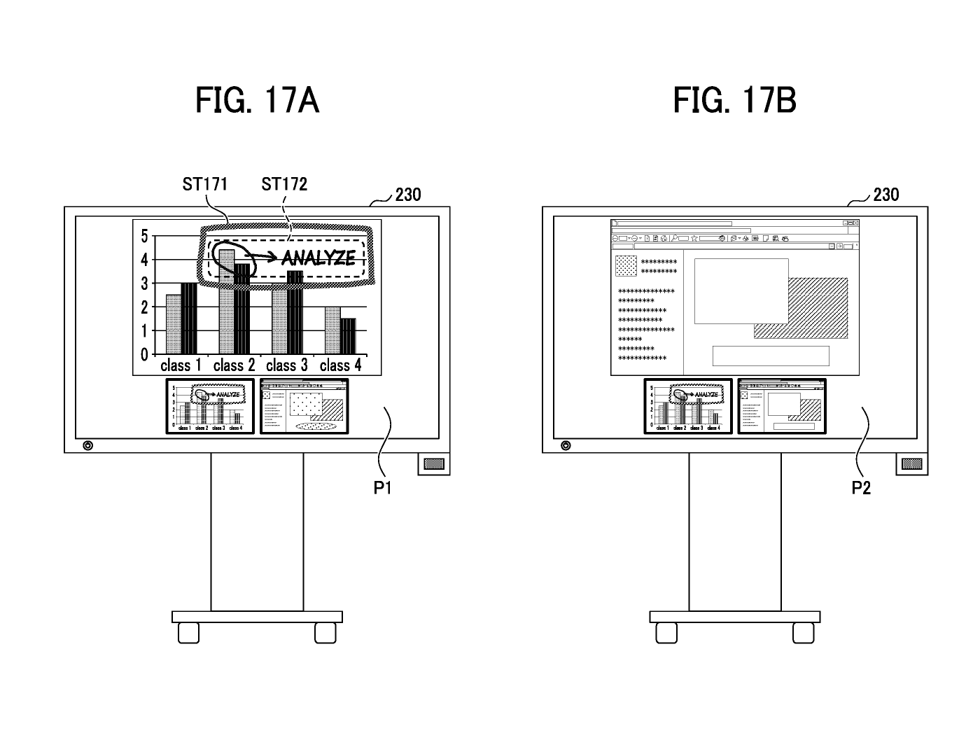

A detailed description is given now of a process performed by the information processing system 100 according to the present embodiment, with reference to FIG. 17 (FIG. 17A and FIG. 17B) to FIG. 19. FIG. 17A and FIG. 17B are illustrations for explaining the process performed by the information processing system 100 according to the first embodiment. FIG. 17A is the illustration of an example of display of a superimposed image that includes a stroke image, and FIG. 17B is the illustration of an example of display of a superimposed image that does not include a stroke image.

A page data P1, which is a superimposed image P1, illustrated in FIG. 17A includes a stroke image ST171 and a stroke image group ST172. In addition, in the superimposed image P1, the stroke image ST171 is defined as a stroke image that is drawn using the specific attribute information set by the attribute setting unit 268.

In the example of FIG. 17A, the PDF data 254 corresponding to the superimposed image P1 includes an image data in the PNG format generated from the superimposed image P1, first stroke information that indicates the stroke image ST171, and second stroke information that indicates each of stroke images included in the stroke image group ST172.

On the other hand, in the superimposed image P2 illustrated in FIG. 17B, there is no stroke image input by manually drawing. Therefore, the PDF data 254 corresponding to the superimposed image P2 includes an image data in the PNG format generated from the superimposed image P2, but no stroke information.

Accordingly, in the server apparatus 300, the PDF data corresponding to the superimposed image P1 is target data to be analyzed for extracting the important matter information, and the PDF data corresponding to the superimposed image P2 is excluded from the target data to be analyzed.

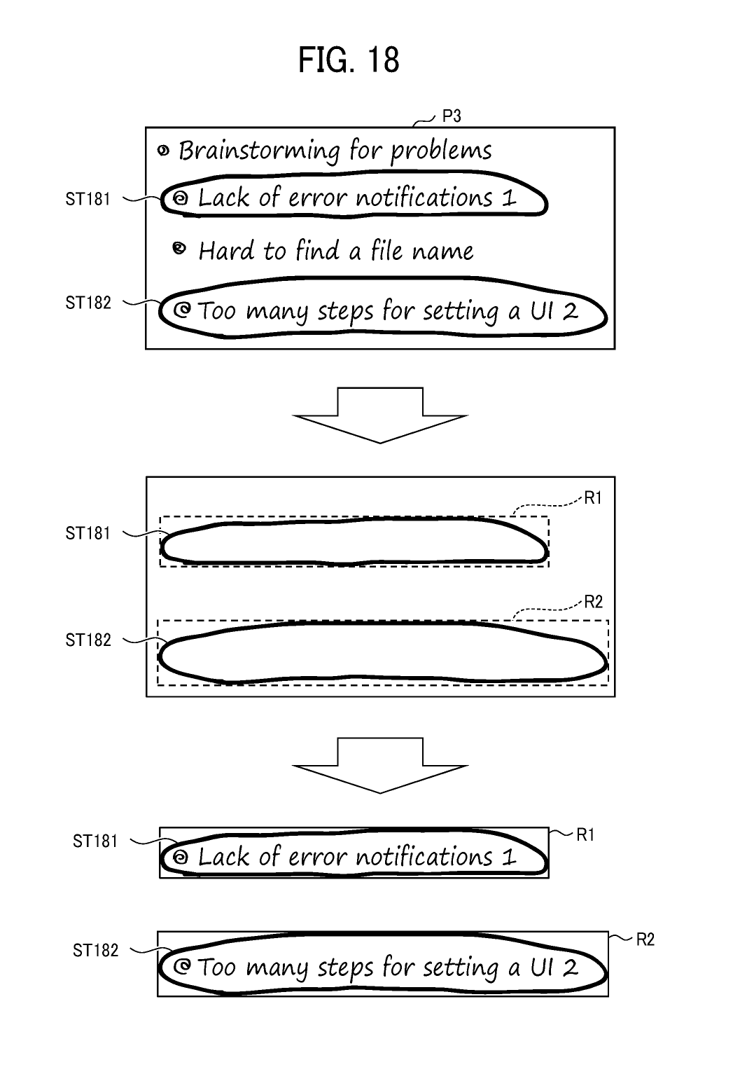

FIG. 18 is an illustration for explaining a process of extracting the important matter information, according to the present embodiment. When the PDF data that includes stroke information is selected in the server apparatus 300 according to the present embodiment, one or more stroke images that are drawn using the specific attribute information are detected from the image data included in the selected PDF data.

An image P3 illustrated in FIG. 18 is an example of an image indicated by image data in the PNG format included in the PDF data selected by the page selection unit 264.

The image P3 includes a stroke image ST181 and a stroke image ST182 drawn using the specific attribute information.

Accordingly, in the server apparatus 300, the important matter extraction unit 365 detects the stroke image ST181 and the stroke image ST182 from the image P3. Then, the important matter extraction unit 365 specifies a region R1 indicated by the stroke image ST181 and a region R2 indicated by the stroke image ST181. In addition, the region R1 is a region within a rectangle circumscribed by the stroke image ST181, and the region R2 is a region within a rectangle circumscribed by the stroke image ST182.

Subsequently, the important matter extraction unit 365 extracts image data in the region R1 and image data in the region R2 from the image data of the image P3 as important matter information.

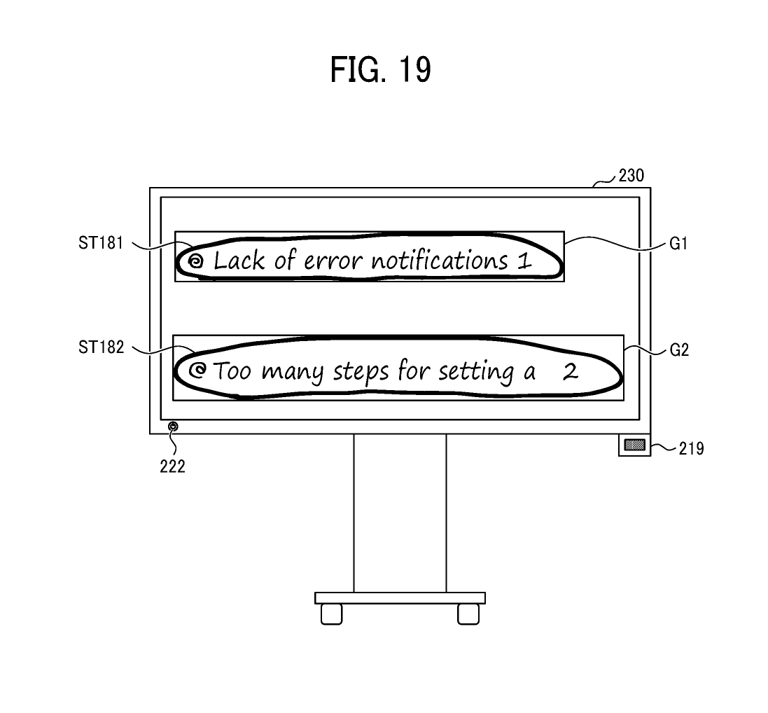

A description is now given of the important matter information list, with reference to FIG. 19. FIG. 19 is an illustration of an example of display of the important matter information list according to the first embodiment.

When the extraction of the important matter information from the PDF data is completed in the server apparatus 300, the electronic whiteboard 200 receives information indicating the important matter information list and displays the important matter information list on the display 230.

In the example of FIG. 19, an image G1 obtained based on the image data in the region R1 in the image P3 and an image G2 obtained based on the image data in the region R2 in the image P3 are displayed on the display 230 as the important matter information list.

As described above, in the information processing system 100 according to the present embodiment, the electronic whiteboard 200 selects the PDF data that includes stroke information and transmits the selected PDF data to the server apparatus 300, and the electronic whiteboard 200 displays the important matter information extracted from the PDF data in the server apparatus 300.

In addition, according to the present embodiment, analysis is performed to extract the important matter information only for the PDF data that includes the stroke information. Accordingly, according to the present embodiment, the time required from when the electronic whiteboard 200 transmits the PDF data to the server apparatus 300 to when the electronic whiteboard 200 receives the information indicating the important matter information list is shortened, resulting in improvement of the operability of the electronic whiteboard 200.

In the present embodiment, whether or not to transmit the PDF data to the server apparatus 300 is determined according to the presence or absence of the stroke information in the PDF data, but the embodiments are not limited to this configuration.

The electronic whiteboard 200 according to some embodiments may monitor the movement of the electronic pen 2500 and the user's hand on the display 230 by capturing an image of the display 230 with the camera 2400, select the PDF data as a target to be analyzed according to a monitoring result, for example. For example, when determining that a stroke image is being input by the electronic pen 2500 or by hand from image data captured by the camera 2400, the electronic whiteboard 200 may select PDF data corresponding a superimposed image of a screen that is currently displayed on the display 230 as a target to be analyzed and transmit the selected PDF data to the server apparatus 300.

In addition, the electronic whiteboard 200 may select superimposed image data that includes stroke image data instead of PDF data, which includes a stroke image, and transmit the selected data to the server apparatus 300. In this case, the server apparatus 300 may detect, from the superimposed image data, a stroke image to which the specific attribute information is set.

Further, in some embodiments, the server apparatus 300 in the information processing system 100 may include a plurality of server apparatuses 300 and any of the plurality of server apparatuses 300 may have the function. Furthermore, the information processing system 100 having a configuration in which the electronic whiteboard 200 is connected to the server apparatus 300 so that the electronic whiteboard 200 and the server apparatus can establish communication is just an example. There are various types of system configurations that are different from each other depending on applications or purposes.

Further, in some embodiments, PDF data that does not include stroke information may also be transmitted to the server apparatus 300 along with the various content data items, for example.

### Second Embodiment

A description is now given of a second embodiment of the present disclosure, with reference to drawings. The second embodiment is different from the firs embodiment in that a determination whether to transmit the content data to the server apparatus 300 each time when an image displayed on the electronic whiteboard 200 is switched. In the following description of the second embodiment, the difference from the first embodiment is focused. In the following description, the same reference numerals are given to the same or corresponding functions or configurations as those of the first embodiment, and redundant descriptions thereof are omitted or simplified appropriately.

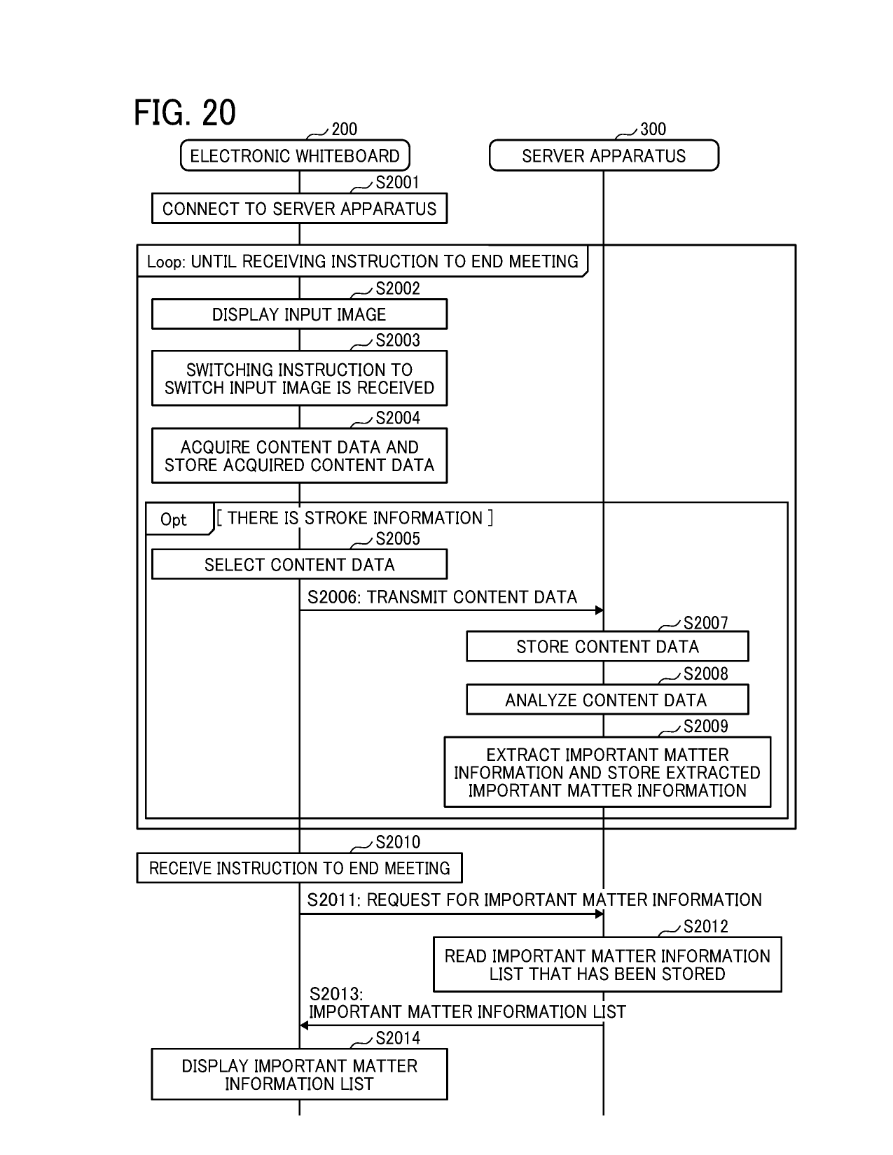

FIG. 20 is a sequence diagram illustrating a process performed by the information processing system 100 according to the second embodiment.

In the information processing system 100 according to the present embodiment, when the input unit 261 receives a connection request to connect to the server apparatus 300, the electronic whiteboard 200 connects to the server apparatus 300 by the communication unit 265 (step S2001). Subsequently, the electronic whiteboard 200 displays an input image acquired by the input unit 261 from, for example, the PC400-2 on the display 230 by the display control unit 260 (step S2002).

Subsequently, the electronic whiteboard 200 receives an input image switching instruction from the input unit 261 (step S2003), acquires content data (content data items) by the page generating unit 263, and stores the content data items in the page storage unit 250 (step S2004).

Subsequently, when stroke information is included in the stored PDF data, the page selection unit 264 of the electronic whiteboard 200 selects the PDF data (step S2005), and transmits the selected PDF data to the server apparatus 300 (step S2006).

Processing from S2007 to S2009 in FIG. 20 is the same as the processing from S1506 to S1508 in FIG. 15, and the description of the processing from S2007 to S2009 in FIG. 20 is omitted here.

The information processing system 100 repeats processing from S2001 to S2009 until the input unit 261 receives an instruction to end the meeting.

Upon receiving an instruction to end the meeting by the input unit 261 (step S2010), the electronic whiteboard 200 transmits a request for an important matter information list to the server apparatus 300 (step S2011).

Processing from S2012 to S2014 in FIG. 20 is the same as the processing from S1509 to S1511 in FIG. 15, and a description of the processing from S2012 to S2014 is omitted here.

As described above, in the present embodiment, each time when PDF data is generated in the electronic whiteboard 200, a determination whether the stroke information is included in the PDF data or not is made. In addition, the electronic whiteboard 200 according to the present embodiment transmits the PDF data to the server apparatus 300 each time when a determination indicating that the stroke information is included in the PDF data is made.

The important matter extraction unit 365 of the server apparatus 300 detects a stroke image to which the specific attribute information is set each time when the PDF data is received.

Accordingly, according to the present embodiment, the important matter information can be extracted each time a content data item is acquired. Therefore, in the present embodiment, the electronic whiteboard 200 can receive from the server apparatus 300 the important matter information list acquired from the page data acquired by a time in middle of the meeting, for example.

### Third Embodiment

A description is now given of a third embodiment of the present disclosure, with reference to drawings. The third embodiment is different form the first embodiment in that an electronic whiteboard 200A extracts important matter information. In the following description of the third embodiment, the difference from the first embodiment is focused. In the following description, the same reference numerals are given to the same or corresponding functions or configurations as those of the first embodiment, and redundant descriptions thereof are omitted or simplified appropriately.

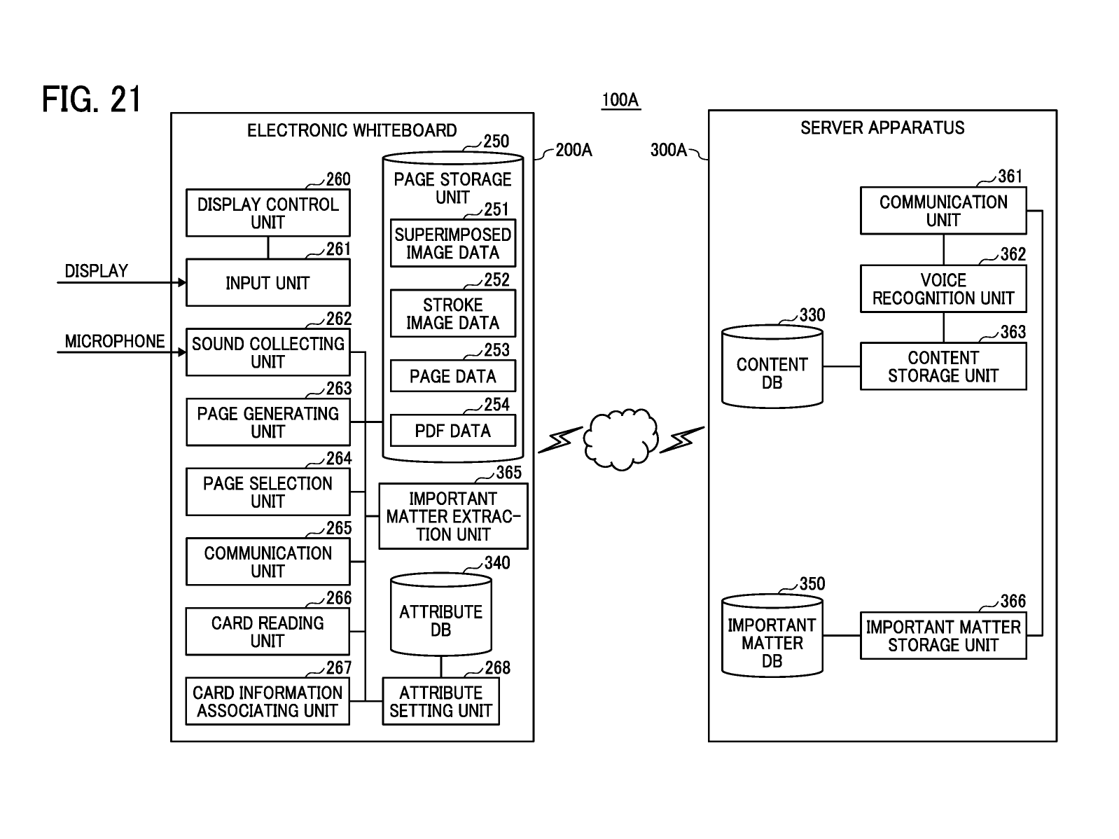

FIG. 21 is a schematic diagram illustrating functions of apparatuses included in an information processing system 100A, according to the third embodiment.

The information processing system 100A according to the present embodiment includes the electronic whiteboard 200A and a server apparatus 300A.

The electronic whiteboard 200A includes a page storage unit 250, a display control unit 260, an input unit 261, a sound collecting unit 262, a page generating unit 263, a page selection unit 264, a communication unit 265, a card reading unit 266, a card information associating unit 267, an attribute setting unit 268, an important matter extraction unit 365, and an attribute database 340.

The communication unit 265 of the electronic whiteboard 200A transmits, to the server apparatus 300A, important matter information extracted by the important matter extraction unit 365.

In addition, the attribute setting unit 268 of the electronic whiteboard 200A according to the present embodiment causes the display 230 to display a list of the attribute information (hereinafter referred to as an attribute information list) stored in the attribute database 340 and retains attribute information selected from the attribute information list as specific attribute information.

The server apparatus 300A according to the present embodiment includes a content database 330, an important matter database 350, a communication unit 361, a voice recognition unit 362, a content storage unit 363, and an important matter storage unit 366.

Upon receiving the important matter information from the electronic whiteboard 200A, the important matter storage unit 366 of the server apparatus 300A stores the important matter information in the important matter database 350.

As described above, in the present embodiment, because the extraction of the important matter information is performed by the electronic whiteboard 200A, the processing load of the server apparatus 300B can be reduced.

### Fourth Embodiment

A description is now given of a fourth embodiment of the present disclosure, with reference to drawings. The fourth embodiment is different form the first embodiment in that an image projection apparatus 700 is used instead of the electronic whiteboard 200 in an information processing system 100B. In the following description of the fourth embodiment, the difference from the first embodiment is focused. In the following description, the same reference numerals are given to the same or corresponding functions or configurations as those of the first embodiment, and redundant descriptions thereof are omitted or simplified appropriately.

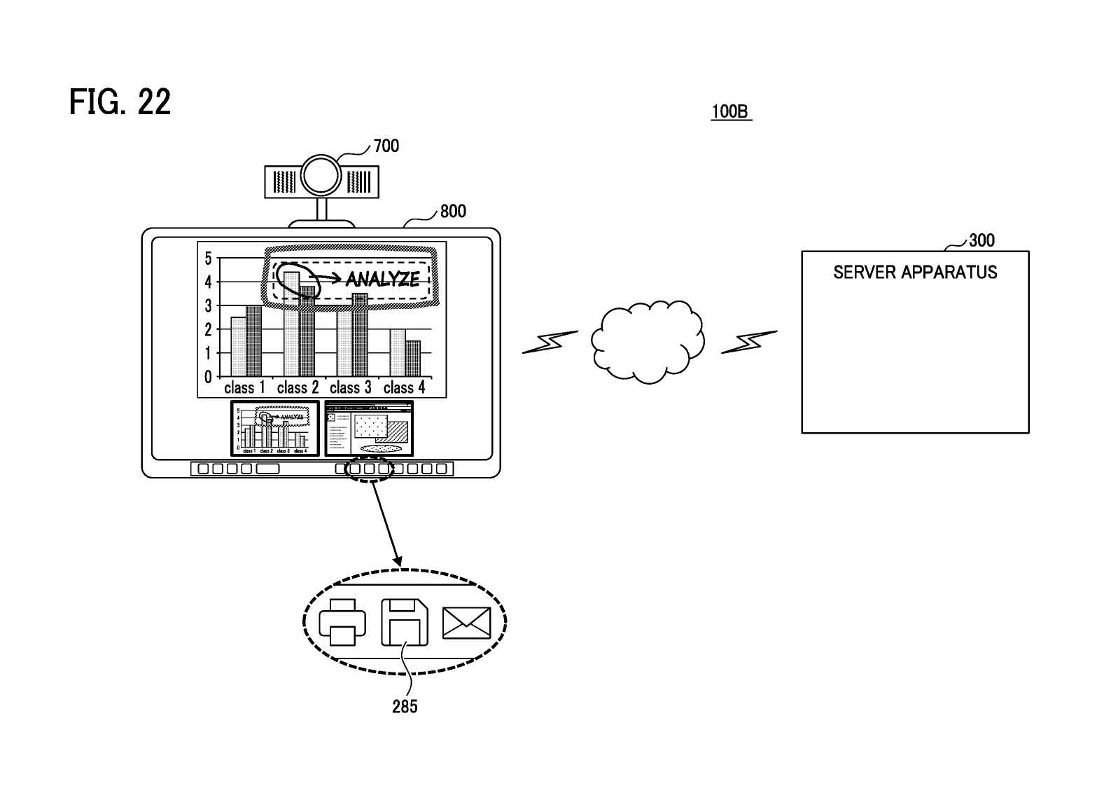

FIG. 22 is an illustration of an overview of the information processing system 100B according to the fourth embodiment. The information processing system 100B illustrated in FIG. 22 includes the image projection apparatus (projector) 700 and the server apparatus 300.

The image projection apparatus 700 projects image data input from, for example, a terminal apparatus connected to the image projection apparatus 700 onto a screen 800. The screen 800 corresponds to the display 230. For example, a whiteboard, a wall surface, or the like can substitute as the screen 800.

In addition, the image projection apparatus 700 detects movement of the electronic pen, user's hand, etc., to detect a handwriting input to the screen 800, and thereby projecting a stroke image onto the screen 800.

In addition, for example, in response to detection of an operation performed with a save button 285 displayed on the screen 800, the image projection apparatus 700 transmits, as content data, image data of the image projected on the screen 800, to the server apparatus 300. More specifically, the image projection apparatus 700 selects, as a target to be analyzed for extracting an important matter, a content data item that includes stroke information among all the content data acquired by the image projection apparatus 700, if there is any, and transmits the selected content data item to the server apparatus 300, as also described in the first to third embodiments.

In addition, for example, in response to detection of an operation performed with the save button 285, the image projection apparatus 700 may output the image data to a portable recording medium such as a USB memory such that the image data is stored in the USB memory to save the page data, in addition to transmitting the page data to the server apparatus 300.

As described above, in the information processing system 100B including the image projection apparatus 700 and the server apparatus 300 according to the present embodiment, the processing load incurred by extracting specific information (important matter information) can be reduced.

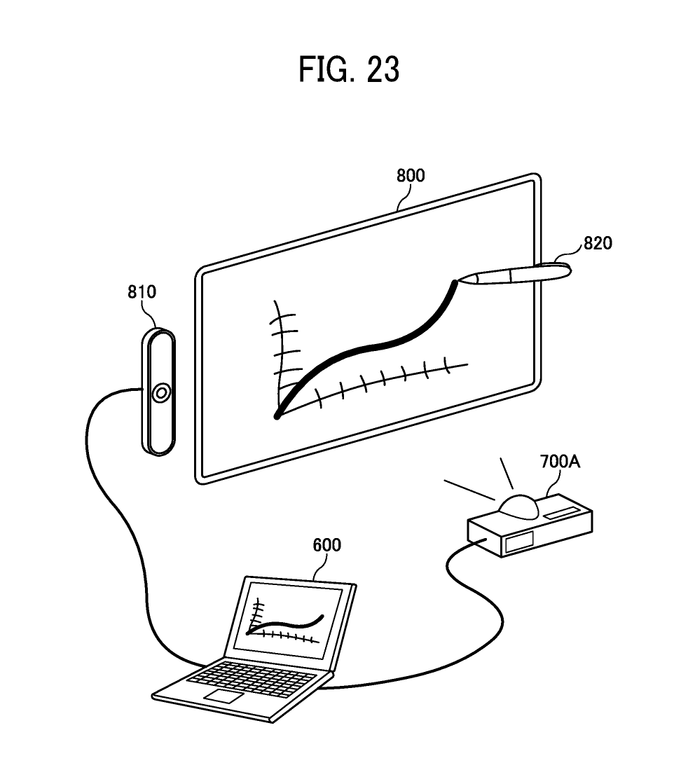

A description is now given of several modifications of the information processing system of each of the above-described embodiments, with reference to FIG. 23 to FIG. 25.

FIG. 23 is a diagram illustrating a first modification of the information processing system according to each of the above-described embodiments. In the example of FIG. 23, an information processing system according to the first modification includes, instead of the electronic whiteboard 200, a terminal apparatus 600, an image projection apparatus 700A, and a pen motion detection apparatus 810.

The terminal apparatus 600 is coupled to the image projection apparatus 700A and the pen motion detection apparatus 810 by wire.

The image projection apparatus 700A projects image data input from the terminal apparatus 600 onto the screen 800.

The pen motion detection apparatus 810 communicates with an electronic pen 820 to detect the motion of the electronic pen 820 in the vicinity of the screen 800. More specifically, the pen motion detection apparatus 810 detects coordinate information indicating a position pointed by the electronic pen 820 on the screen 800 and transmits the coordinate information to the terminal apparatus 600.

Based on the coordinate information received from the pen motion detection apparatus 810, the terminal apparatus 600 generates stroke image data of a stroke image input by the electronic pen 820 and causes the image projection apparatus 700A to project the stroke image on the screen 800.

In addition, the terminal apparatus 600 generates content data (a plurality of content data items) including superimposed image data indicating the image projected by the image projection apparatus 700A. Then, the terminal apparatus 600 selects a content data item that includes stroke information from the content data and transmits the selected content data item to the server apparatus 300.

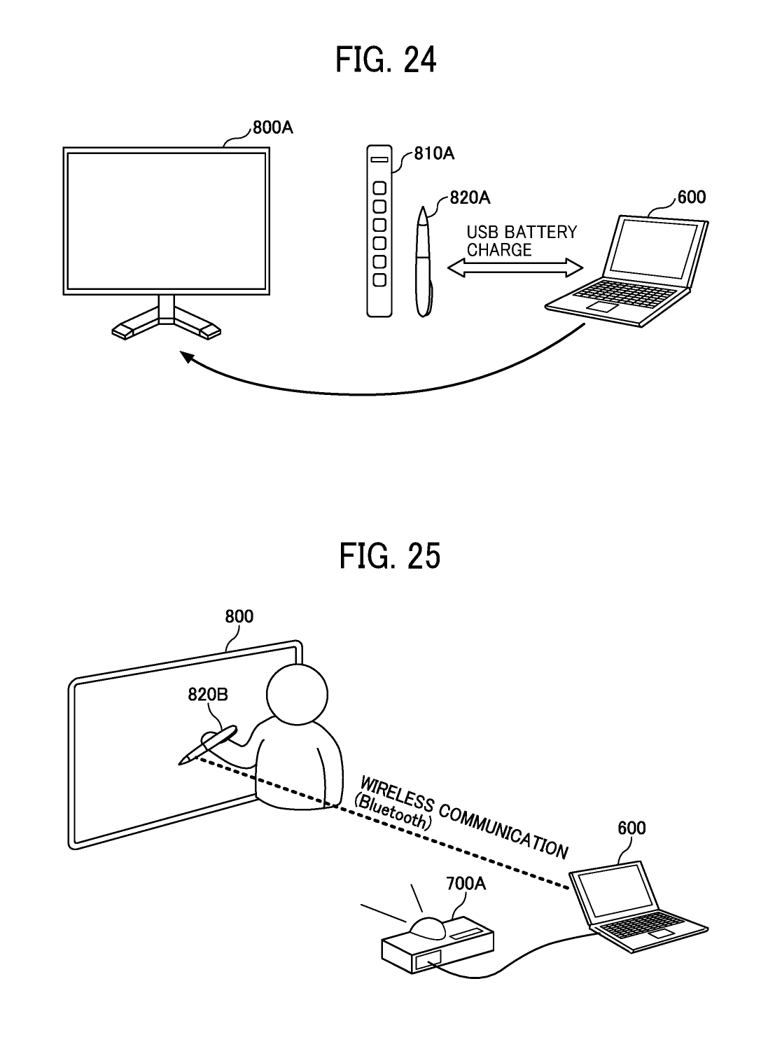

FIG. 24 is a diagram illustrating a second modification of the information processing system. In the example of FIG. 24, an information processing system according to the second modification includes, instead of the electronic whiteboard 200, the terminal apparatus 600, a display 800A, and the pen motion detection apparatus 810.

The pen motion detection apparatus 810, which is disposed in the vicinity of the display 800A, detects coordinate information indicating a position pointed by an electronic pen 820A on the display 800A and transmits the coordinate information to the terminal apparatus 600. In the example of FIG. 24, the electronic pen 820A can be charged from the terminal apparatus 600 via a USB connector.

Based on the coordinate information received from the pen motion detection apparatus 810, the terminal apparatus 600 generates image data of stroke image input by the electronic pen 820 and displays an image based on the image data of stroke image on the display 800A.

In addition, the terminal apparatus 600 according to the present embodiment generates content data (a plurality of content data items) including superimposed image data indicating the image projected by the image projection apparatus 700A. Then, the terminal apparatus 600 selects a content data item that includes stroke information from the content data items and transmits the selected content data item to the server apparatus 300.

FIG. 25 is a diagram illustrating a third modification of the information processing system. In the example of FIG. 25, an information processing system according to the third modification includes, instead of the electronic whiteboard 200, the terminal apparatus 600 and the image projection apparatus 700A.

The terminal apparatus 600 communicates with an electronic pen 820B through a wireless network such as Bluetooth, to receive coordinate information of a position pointed by the electronic pen 820B on the screen 800. Based on the received coordinate information, the terminal apparatus 600 generates image data of a stroke image input by the electronic pen 820B and causes the image projection apparatus 700A to project the stroke image on the screen 800.

In addition, the terminal apparatus 600 generates content data (a plurality of content data items) including superimposed image data indicating the image projected by the image projection apparatus 700A. Then, the terminal apparatus 600 selects a content data item that includes stroke information from the content data items and transmits the selected content data item to the server apparatus 300.

According to one of the embodiments of the disclosure described above, the processing load incurred by extracting specific information can be reduced.

As described above, each of the embodiments can be applied to various system configurations.

Any one of the above-described operations may be performed in various other ways, for example, in an order different from the one described above.

Numerous additional modifications and variations are possible in light of the above teachings. It is therefore to be understood that, within the scope of the appended claims, the disclosure of this patent specification may be practiced otherwise than as specifically described herein. For example, elements and/or features of different illustrative embodiments may be combined with each other and/or substituted for each other within the scope of this disclosure and appended claims.

As can be appreciated by those skilled in the computer arts, the disclosure may be implemented as convenient using a conventional general-purpose digital computer programmed according to the teachings of the present specification. Appropriate software coding can readily be prepared by skilled programmers based on the teachings of the present disclosure, as will be apparent to those skilled in the software arts. The present disclosure may also be implemented by the preparation of application-specific integrated circuits or by interconnecting an appropriate network of conventional component circuits, as will be readily apparent to those skilled in the relevant art.

Each of the functions of the described embodiments may be implemented by one or more processing circuits. A processing circuit includes a programmed processor. A processing circuit also includes devices such as an application specific integrated circuit (ASIC) and conventional circuit components arranged to perform the recited functions.

The processing circuitry is implemented as at least a portion of a microprocessor. The processing circuitry may be implemented using one or more circuits, one or more microprocessors, microcontrollers, application specific integrated circuits, dedicated hardware, digital signal processors (DSPs), microcomputers, central processing units, a field programmable gate arrays (FPGAs), programmable logic devices, state machines, super computers, or any combination thereof. Also, the processing circuitry may include one or more software modules executable within one or more processing circuits. The processing circuitry may further include memory configured to store instructions and/or code that causes the processing circuitry to execute functions.

If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

What is claimed is:

1. A terminal apparatus, comprising circuitry configured to:
generate a plurality of content data items based on display image data displayed on a display; and
select, from among the plurality of content data items, at least one content data item that includes stroke information indicating a stroke image, as target data subjected to detection of stroke image data to which specific attribute information is set, the stroke image being an image of a trajectory of a stroke that is a handwriting input made on the display.

2. The terminal apparatus of claim 1,
wherein the plurality of content data items, from which the at least one content data is selected, is generated during a period of time from when a first instruction is received to when a second instruction is received.

3. The terminal apparatus of claim 1,
wherein the circuitry
determines, for each one of the content data items generated, whether the content data item includes stroke information each time when the content data item is generated, and
selects the at least one content data item that includes stroke information as target data based on a determination.

4. The terminal apparatus of claim 1,
wherein the circuitry superimposes the stroke image on an input image input on the display to generate the display image data, in response to an input of the stroke image on the display,
wherein the at least one content data item includes the display image data and the stroke information that is information on the stroke image, in association with each other.

5. The terminal apparatus of claim 1,
wherein each of the plurality of content data items is data in a portable document format, and the stroke information is information in a vector format.

6. The terminal apparatus of claim 1,
wherein the circuitry detects, from the selected content data item, a stroke image to which the specific attribute information is set and extracts image data in a region indicated by the detected stroke image as important matter information.

7. The terminal apparatus of claim 1,
wherein the specific attribute information is information indicating that the stroke image to which the specific attribute information is set is an image specifying important matter information.

8. An information processing system, comprising:
a terminal apparatus; and
an information processing apparatus communicably connected with the terminal apparatus,
the terminal apparatus including first circuitry configured to
generate a plurality of content data items based on display image data displayed on a display,
select at least one content data item that includes stroke information indicating a stroke image, from the plurality of content data items, as target data to be processed to detect stroke image data to which specific attribute information is set, the stroke image being an image of a trajectory of a stroke that is a handwriting input on the display, and
transmit the selected content data item to the information processing apparatus, and
the information processing apparatus including second circuitry configured to
detect, from the content data item transmitted from the terminal apparatus, a stroke image to which specific attribute information is set, and
extract image data in a region specified by the detected stroke image as important matter information.

9. A method of processing information, comprising:
generating a plurality of content data items based on display image data displayed on a display, and
selecting at least one content data item that includes stroke information indicating a stroke image, from the generated plurality of content data items, as target data to be processed to detect stroke image data to which specific attribute information is set, the stroke image being an image of a trajectory of a stroke that is a handwriting input on the display.

10. The method of processing information of claim 9, further comprising:
detecting, from the selected content data item, a stroke image to which the specific attribute information is set; and
extracting image data in a region indicated by the detected stroke image as important matter information.
